(19) United States
(12) Patent Application Publication
(10) Pub. No.: US 2012/0036039 A1
(43) Pub. Date: Feb. 9, 2012

(54) Method for Electronically Ordering Journals and Publications by a Consortium

(76) Inventors: Frank Keener, Chelsea, AL (US); Rebecca S D Tucker, Birmingham, AL (US)

(21) Appl. No.: 13/208,056

(22) Filed: Aug. 11, 2011

Related U.S. Application Data
(63) Continuation-in-part of application No. 12/044,525, filed on Mar. 7, 2008, now abandoned.
(60) Provisional application No. 60/893,399, filed on Mar. 7, 2007.

(51) Int. Cl. G06Q 30/06

(52) U.S. Cl. 705/26.8

(57) ABSTRACT

A method for handling the entry and audit of new and renewal orders for all formats of content. The method assists with automatically populating library discovery tools, providing pre-financing, and prompt payment, tracking individual package components, providing automatic detailed invoice loads to integrated customer systems and automatically auditing package contents, and bringing efficiencies to the renewal process by ensuring a consortium's renewal order complies with the publisher license commitments. The method ensures compliance with regard to licensing terms, price caps, minimum spend, titles added, titles sold, and titles deleted.

### CROSS REFERENCE TO RELATED PATENT APPLICATIONS

This application is a continuation-in-part of U.S. patent application Ser. No. 12/044525, filed on Mar. 7, 2008 and currently pending, which claims the benefit of priority of U.S. provisional application Ser. No. 60/893,399, filed on Mar. 7, 2007, said applications being relied upon and incorporated herein by reference.

### BACKGROUND OF THE INVENTION

As the business of subscribing evolves from print to electronic a number of challenges arise for all parties concerned: the Customer; the Publisher; and the Agent or fulfillment office. Existing subscription tools do not effectively support the subscriptions for electronic journals and publications. Existing processes for physical subscriptions are labor-intensive and inefficient, and are addressed by the method discussed herein.

### SUMMARY OF THE INVENTION

A method for allowing Customers of journal and publication resources to electronically review their current titles within their packages in a consortium, drop titles that they do not want to carry for the next year, and add new titles is described herein. These steps are all performed within the confines of the contract between the consortium and the Publisher of the journals and publications. Further, it is desired for the Agent and the Publisher to have more timely subscription information and create an accurate picture of what the Customer will be doing for the next year as it relates to their subscription. In addition, by having an electronic method of filling these orders, the conventional processing time will be reduced and provide a labor cost savings for the Agent and the Publisher.

### DESCRIPTION OF THE DRAWINGS

FIGS. 1a and 1b are block diagrams illustrating the components of the system;

FIGS. 2a and 2b illustrate a flow chart of the process for placing and amending an order for a publication from a Publisher by a Customer via an Agent;

FIG. 3 is a flow chart illustrating the steps for adding and dropping in the Publisher Data Import Engine;

FIGS. 4a and 4b are flow charts illustrating New Year Price list import into the Publisher Data Import Engine;

FIG. 5 is a flow chart illustrating the data flow of the “Year One Customer” import of the Customer Price List;

FIGS. 6 and 7 illustrate the steps involved with the Publisher Data Rules Engine in importing data;

FIGS. 8-26 illustrate tables for different calculations performed by the system;

FIGS. 27-38 illustrate screen shots of the web interface viewed by the Customers in maintaining account information;

FIG. 39 is a block diagram illustrating the components of the system;

FIG. 40 workflow diagram illustrating the handling of consortium subscriptions with Agents and Publishers;

FIG. 41 is a workflow diagram of the decision process regarding whether individual accounts of a consortium meet terms of the consortium contract; and

FIG. 42 is a screen shot of the web interface viewed by the consortium.

### DESCRIPTION OF THE INVENTION

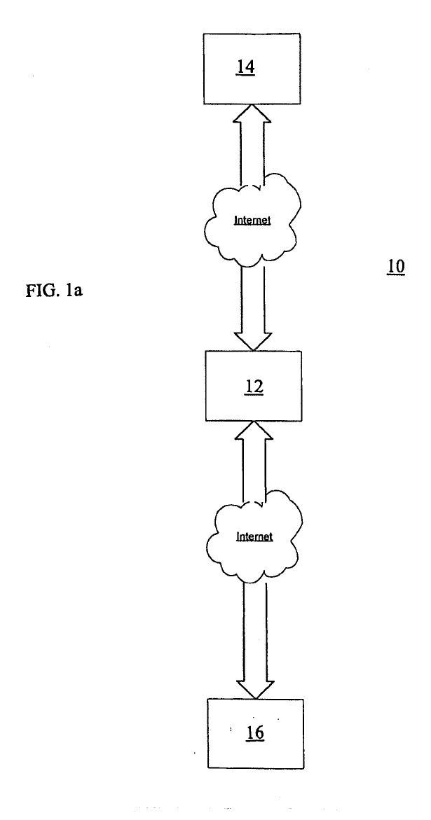

Referring to the attached Figures, a method for using subscription agent interface to handle the entry and audit of new and renewal orders for all formats of a party's content, including electronic-only packages, electronic top-off deals, and consortium arrangements, is described and illustrated herein. Looking to FIGS. 1a and 1b, the method is performed in a network 10 of computers that are operated by an Agent, one or more Publishers, and one or more Customers, that may be members of a Consortium directed by a Consortium Leader. Specifically, an Agent computer 12 is operated by an Agent and connected to one or more Publisher computers 14 (operated by a publisher) and one or more Customer computers 16 (operated by customer) via an internet connection or some other electrical connection. It is to be noted that, although the Agent computer 12 implies a single computer, it may actually include a number of computers on a network operated and maintained by various individuals identified as Agents, and it may further include equipment and media for securely storing information. The interface among parties significantly improves processes currently used by Publishers and their Customers in adding and accurately maintaining subscriptions to journals and periodicals.

The detailed description that follows is represented largely in terms of processes and symbolic representations of operations by conventional computer components, including a processing unit (a processor), memory storage devices, connected display devices, and input devices. These processes and operations may utilize conventional computer components in a heterogeneous distributed computing environment, including remote file servers, computer servers, and memory storage devices. Each of these conventional distributed computing components is accessible by the processor via a communication network.

The processes and operations performed by each computer (Agent, Customer, and Publisher) include the manipulation of signals by a processor and the maintenance of these signals within data structures resident in one or more memory storage devices. For the purposes of this discussion, a process is generally conceived to be a sequence of computer-executed steps leading to a desired result. These steps usually require physical manipulations of physical quantities. Usually, though not necessarily, these quantities take the form of electrical, magnetic, or optical signals capable of being stored, transferred., combined, compared, or otherwise manipulated. It is convention for those skilled in the art to refer to representations of these signals as bits, bytes, words, information, elements, symbols, characters, numbers, points, data, entries, objects, images, files, or the like. It should be kept in mind, however, that these and similar terms are associated with appropriate physical quantities for computer operations, and that these terms are merely conventional labels applied to physical quantities that exist within and during operation of the computer.

It should also be understood that manipulations within the computer are often referred to in terms such as creating, adding, calculating, comparing, moving, receiving, determining, identifying, populating, loading, executing, etc. that are often associated with manual operations performed by a human operator. The operations described herein are machine operations performed in conjunction with various input provided by a human operator or user that interacts with the computer.

In addition, it should be understood that the programs, processes, methods, etc. described herein are not related or limited to any particular computer or apparatus. Rather, various types of general purpose machines may be used with the program modules constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory, such as read-only memory.

As described in greater detail herein, the interface between Agents, Customers, and Publishers assists with automatically populating library discovery tools without delay, providing pre-financing and prompt payment, tracking individual package components, providing automatic detailed invoice loads to integrated library systems and automatically auditing package contents, and bringing efficiencies to the e-package renewal process by ensuring a Customer's renewal order complies with the Publisher license commitments. The interface among the Agent, Customer, and Publisher insures compliance with regard to things such as price caps, minimum spend, titles added, and titles sold or deleted.

The subscription agent interface described herein allows content collection managers within Customers, such as libraries and corporations, to quickly and accurately order license negotiated content collections and/or packages from Publishers. The web-based application improves the electronic content journal collection/package ordering and renewal process by programmatically applying the ordering parameters/rules of a purchase defined in the license agreement between the library and the purchaser. The application is used annually by Customers (librarians and persons in related positions) to ensure that changes made to their electronic content journal collection/package orders adhere to the parameters of their license agreement with Publishers so that all orders are sent correctly with minimum administrative effort.

The method described herein provides a consistent electronic interface for libraries and corporations at Customer computers 16 to annually manipulate (additions, deletions, new purchases, etc.) large collections of electronic journal content swiftly without violating the terms of the numerous license agreements that the library/corporation have executed with many Publishers of electronic content. As noted above, the electronic interface described herein is internet based, although it is foreseen that other options may be available. For example, in another potential embodiment, it is foreseen that an electronic data interchange (EDI) output is provided directly to the Publishers or subscription Agent's ordering system and the content host's activation and authentication system. That is, rather than a web based system, EDI may be used for computer-to-computer transmissions of unambiguous subscription information.

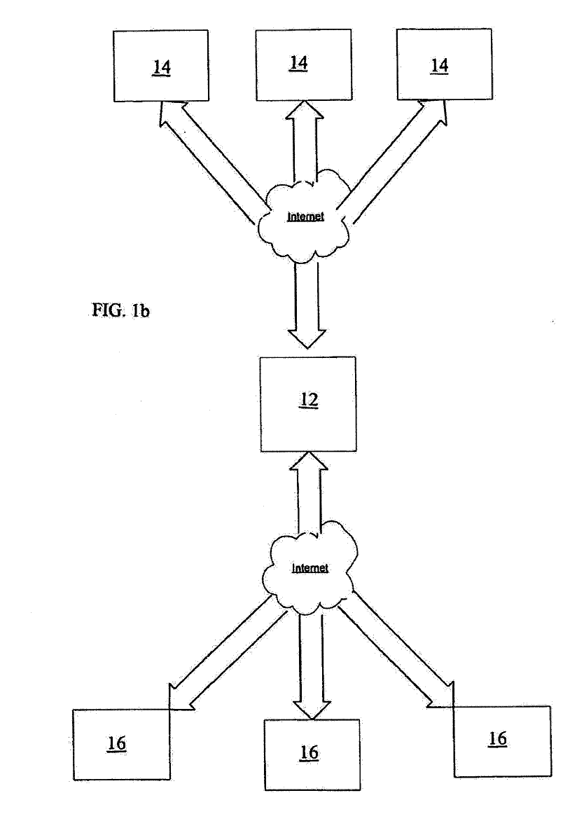

The process of placing orders between Publishers and Customers, via the Agent's computer 10, is illustrated in FIGS. 2a and 2b. Initially, the Customer (such as a library) negotiates license terms with a Publisher at step 100. This is done by direct contact, either electronically or in person, between the Publisher and the Customer. The Publisher, via the Publisher's computer 14, will transmit the license terms to the Agent's computer 12 at step 102, and the Agent will receive and input the license terms into the system (step 104). The terms are generally entered via a conventional data file, such as a spreadsheet, that may be transmitted by a standard form of memory to the Agent computer 12 or via electronic transfer, such as via the internet. The spreadsheet implemented by the system can be one generated by any general-purpose spreadsheet application software, such as Excel (general-purpose spreadsheet application software available from Microsoft Corporation) or Lotus 1-2-3 (general-purpose spreadsheet application software available from Lotus Development Corporation). Once the data is entered, the Agent computer 12 will calculate the license parameters (step 106) for the production of a purchase list with the calculated license terms (step 112). In the meantime, the Agent will maintain order history in the database (step 108), and the Agent computer 12 will pull library prior year holdings from an Agent database (step 110) and use that information to produce the purchase list with calculated terms 112. The Publisher computer 14 will transmit pricing, added titles, and dropped titles to the Agent computer 12 (step 114), and the Agent computer 12 will input the pricing, added titles, and dropped titles into the system (step 116), which is additionally used with the data from steps 106 and 110 to produce the purchase list (step 112). The system will then transmit the purchase package via the internet (step 118) or a similar telecommunications channel to the Customer's computer system 16.

The Customer computer 16 will then adjust the holdings list (step 120) maintained in the Customer computer 16 from the supplied information. The Agent computer 12 will monitor list adjustments for potential license term violations (step 122), and the Customer computer 12 again will adjust the holdings list (step 124) according to the information provided from step 122. The Customer will then finalize their order (step 126), and the Agent computer 12 will review the order for license compliance (step 128). If the order is not appropriate, it will be directed back to the Customer at step 130. If the order is compliant with license terms, then the Agent computer 12 will request an electronic signature (step 132) from the Customer. The Customer will transmit an electronic signature 134 to the Agent computer 12. The system will transmit the order to the Agent (step 136), and the Agent computer 12 will then update the order history database 138 in the Agent computer 12. The Agent will then the transmit order and signature document to the Publisher at step 140, and the Publisher will receive the order (step 142) and generate and transmit the invoice (step 144) to the agent. Substantially concurrently, the Customer will pay the Agent 148, and the Agent will receive and pay the invoice provided by the Publisher (step 146). The Publisher will then turn on web access to purchased content 150, or prepare for mailing of paper content, and the Customer will be able to view purchased online content or begin receiving the print subscription (step 152).

Looking further to the drawings, the network or system 10, and in particular the Agent computer 12 of the network, implements a rules based engine that can apply (via a configuration utility) to all Publishers and their Customers. As used herein, engine is defined as a software application written by a person having ordinary skill in the art to process the actions described herein. The system 10 will maintain and show the Customer's current package titles, any mandatory additional titles, and any titles that are no longer available. It will allow the Customer to swap titles (per the contract amount), and will allow the Customer to add titles to their subscription. It will also produce a quote reflecting any changes made and will send the information to the Agent. The system 10 will produce a spreadsheet or similar document or file based on the generated quote that can be loaded via a program for collections, or subject matter groups (“PAC program”) straight into the Orders History system in the Agent computer 12. The loading of the spreadsheet via the PAC program will be handled outside the application by the regional Agent offices once they have verified the order.

Further, based on the Customer's contract, the system 10 will show what the Customer spent last year, the price increase due to new mandatory titles, the price decrease due to titles that are not longer available, the next year's target amount expenditure. It will allow the Customer to drop titles (per the contract amount).

The implementation of the application will be as follows. The central computer or Agent computer 12, which is maintained by the Agent, will provide a secure site website (HTTPS) accessible by both Customers and Publishers. The system 10 may be designed by utilizing three physical equipment rings protected by firewalls and incorporating a DMZ, or a computer host or small network inserted as a neutral zone between the Agent's private network and the outside public network. The DMZ will prevent outside users from getting direct access to a server that has sensitive or confidential data. The Agent computer 12 will utilize Windows authentication and security systems with both the Publisher computer 14 and the Customer computer 16, and limit access to the website will be through individual usernames and passwords. Customers will be restricted to access only that particular Customer's data by Publisher. It is anticipated that at the most, Customers will need possibly two accounts into the system 10. One account will have read/write authority and the second account will only have read authority. Publisher Services will create the user accounts and identifications within Windows to allow the Publishers access to the system 10.

Although the illustrative embodiment will be generally described in the context of an application program running on a personal computer, those skilled in the art will recognize that the present invention may be implemented in conjunction with operating system programs or with other types of-program modules for other types of computers. Furthermore, those skilled in the art will recognize that the present invention may be implemented in a stand-alone or in a distributed computing environment. In a distributed computing environment, program modules may be physically located in different local and remote memory storage devices. Execution of the program modules may occur locally in a stand-alone manner or remotely in a client server manner. Examples of such distributed computing environments include local area networks and the Internet.

The general website maintained by the Agent computer 10 is designed to meet the following requirements. The site will be designed to support 50% more than the highest number of expected concurrent users during peak periods with a typical response time. Initial estimates are that the system should be designed to handle 15 concurrent users, although this number will vary over time. All Publisher sites will be based on the same template. The creation of the individual sites will be based on the same template but with a unique set of “parts.” Insertion of custom functionality and features for a given Publisher will be done without affecting other Publisher sites.

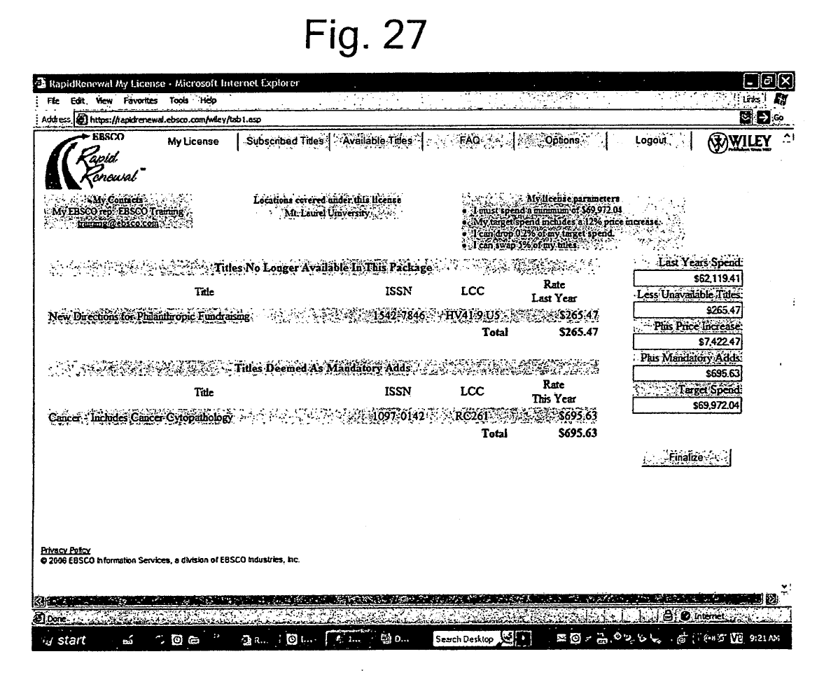

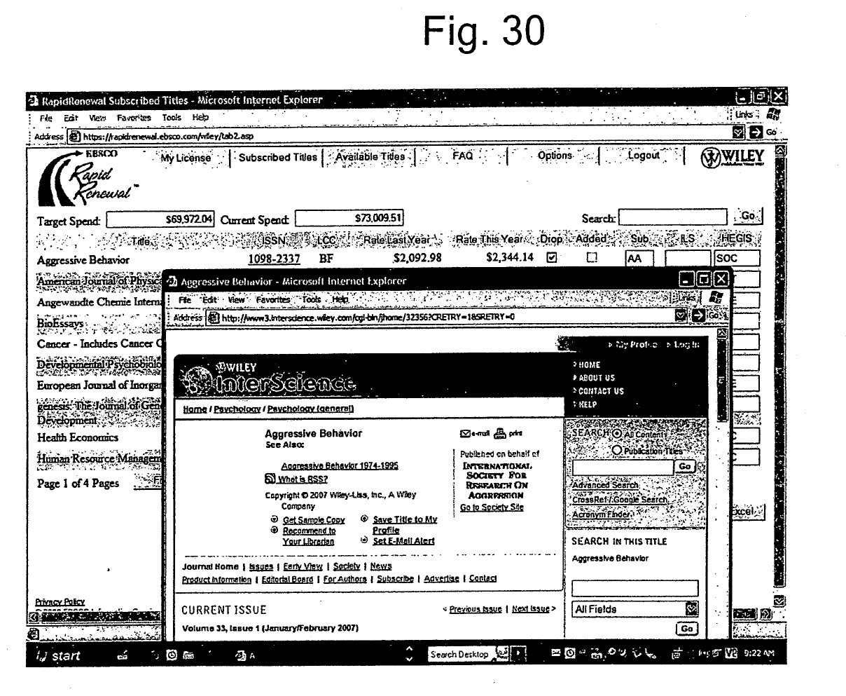

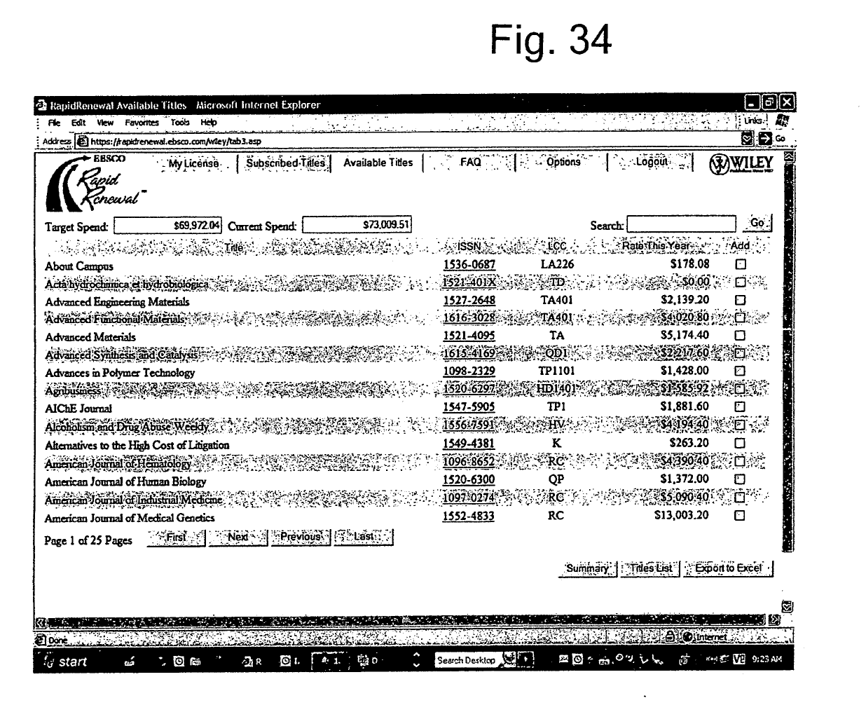

The following items will be common elements among the different sections and web pages generated by the Agent computer 12, illustrated in FIGS. 27 through 38. The License Information Page, Adjustment Page, and Available Titles Page will display the logo of the Publisher for the user to clearly view, such as in the top right hand corner of the page. The logo will be based on the Publisher and account number that is selected in the Preference page. Each section/page may have a “Contact Box” that will display information as to who the Customer should contact at Agent for that particular page that they are on if they feel that the information displayed is not correct. The above information will vary by Customer so it should be associated to the Customer and not the Publisher. Some of the sections/pages may have some type of search option. It is not anticipated that the search option will be using any type of Boolean Logic search engine, but the search elements will be available per search option and will be specific for the type of information that can/should be available depending from which section/page that the search is being performed. All the drill down information will need to be displayed in a grid format. In the each of the sections/pages that lists the search elements will be broken down into different grid formats by subsection.

The Agent computer 12 has a Publisher Data Import Engine to import data from the Publisher computer 14 about the current subscriptions held by each Customer and the available title offerings and the corresponding cost for the respective year. The Publisher Data Import Engine is a software application run on the Agent computer 12 to import the respective information for the Publisher and corresponding Client into a database in the Agent computer 12, and may operate via an FTP (file transfer protocol) connection directly between the Agent computer 12 and the Publisher computer 14 or Client computer 16, such connection being known in the art, or via another file transfer from the Publisher computer 14 or Client computer 16, such as by sending a file attachment via email or similar means between the Publisher and Agent.

Each Publisher will be given a standard Publisher's spreadsheet by the Agent with default fields that will be completed by the Publisher. The Publisher's spreadsheet is designed and constructed by the Agent for the Agent to maintain. It is foreseen that the Publisher's spreadsheet will contain four basic sections or tabs, although other variations are permissible. The first section will be the next year's Publisher's title and price list (referred to as General Price List from this point forward). The second section will be the specialized price list by Customer (if any) for all the titles (referred to Custom Price List). The third section will be a list of the Publisher's Customers and their current title list (referred to as Customer Title List from this point forward). The fourth section will be a list of the mandatory title additions and title drops by Customer (referred to as Add/Drop List from this point forward). For a first year Customer all four tabs on the spreadsheet will need completed by the Publisher. For a second year Customer, only the General Price List, Custom Price List and Add/Drop List will need to be provided by the Publisher. The Customer Title List information will already be in the database from the previous year. The goal is for the Agent to receive this spreadsheet from the Publishers and to import the spreadsheet into the database or data warehouse in the Agent computer 12 in order to populate it.

The General Price List may substantially include the following elements, and the description or options for these elements should be used as a drop down option for the respective element. First, the General Price List will include the Publication Year, which is the year that this General Price List is intended to be used for. The General Price List will also include a description of the Journal Title and the JID, which is the Publisher Product Code for the title. It will further include the International Standard Serial Number (“ISSN”) that identifies a serial publication uniquely. It will include both the print ISSN and the online ISSN, if available. The General Price List will also include the Print Plus Online information, which identifies the discount for combined print and online subscriptions. This information can be a Deeply Discounted Print (“DDP”) price, a Dual Access price, both, or neither. The General Price List will further include the Status of the Publication, such as the status of the Current Publication, whether it has Merged with another publication or had a Title Change, whether it is Not Yet Published, and if it has ceased publication. The General Price List will include the U.S. Print Rate, or the price for a one-year print subscription for Customers based in the United States, the postage rate that will be applied if the subscription is a print title, and the U.S. Online Rate, which is the price for a one-year online subscription for Customers based in the United States (this does not include any Print Plus Online fees). The General Price List also includes a description field indicating if there are any other significant changes that have not been documented above. This field is a free form text field for the client to indicate the changes noted in above. The General Price List will also have a Last Updated field, indicating the date that the Publisher last updated the information with the Agent. Finally, a Comments field may be present to provide a field for the Publisher to add any general comments about that particular title that Publisher would like the Customers to see.

The Agent computer 12 will also maintain a Custom Price List for information concerning specific Customers. The Custom Price List will include the Customer's Name and the Customer Reference Number assigned to the Customer by the Agent. It will further include consortium membership information for the Customer 16, defining whether the Customer 16 belongs to a specific consortium 17 (as discussed herein), such as a library consortium, and providing specific information about the consortium 17 if appropriate. The Custom Price List will further include the Publication Year, or the year that the General Price List is intended to be used for. As with the General Price List, the Custom Price List will include the Journal Title, the JID, the print ISSN, the online ISSN (if available), the Print Plus Online information, and status information regarding the publication (e.g., whether it is current, merged, any title changes, and whether it is to be published). It further includes the print rate, postage rate, and online rate for Customers based in the United States. Finally, the Custom Price List will include a field indicating the date that the Publisher last updated the information provided to the Agent, and a Description Field allowing the Publisher to add any general comments about the particular title that the Publisher would like Customers to see.

A Customer Title List will also be provided by the Agent to the Customer, which is a one time load for each Customer. For a second year Customer, this information will already exist in the database maintained by the Agent computer 12 from the previous year with the Order History. The Customer Title List will include the Customer, a reference number generated by the Agent for the particular Customer that is pre-filled by the Agent. The Customer Title List will also include Consortium Membership information, identifying whether the Customer belongs to a consortium 17, such as a library consortium. The Customer Title List will further include the Journal Titles subscribed to by the Customer, the respective JID Publisher Product Code for the respective titles, the ISSN (both print and online, if appropriate), the Print Plus Online information (there will not be an amount because it is assumed that the fee will be applied to the current year's rate), the print rate charge by journal to the Customer in the last year, and the online rate charged by journal to the Customer in the last year.

The Add/Drop List is also maintained by the Agent computer 12. The Add/Drop List is the Mandatory Titles and Unavailable Titles for each Customer. This list is provided by the Publisher that must be imported by the Agent every year. It will include the Journal Title and the Status of each journal title, that is whether it is a mandatory add or a dropped title. It will include the Publisher Number assigned by the Agent for the new or current Publisher submitting the spreadsheet, which will be populated in the file by the Agent, and it will need to be completed regardless of whether the Journal Title is a Add or Drop record.

The Add/Drop list will additionally include the Publisher Name for the Publisher that the Publisher Title is purchased from, and whether the Publisher being added is Old or New. If the Client wishes to drop the Journal Title, then this field will be blank. If the Publisher is an Old/Add, then the Publisher Number previously assigned by the Agent for the old Publisher will be used. This will need to be completed regardless of whether this is a Add or Drop record. The Add/Drop List will further include the JID-Old/Add, and the Journal ID for the old Publisher from whom the title was purchased. If the Publisher is new, then the Publisher will provide the information. If the title is a Drop record, this field will be blank. If the Publication is being dropped, then JID—Drop information is provided, and this is the Journal ID for the Publisher filling out the spreadsheet and should be defined for each Publisher by the Agent. If this is an Add record, this field will be blank. The Add/Drop List will additionally include the print and online ISSN, as well as information regarding whether the subscription is Print Plus Online (this option will be for Journals Added).

The Add/Drop List will additionally include the Drop Rate, which is the price that will need to be deducted from the Customer's title cost for a dropped title. This rate will only need to be provided for first year Customers. During the second year the rate will be in the database from the previous year. Likewise, the Add/Drop List will include the Add Rate, which is the price that will need to be added from the Customer's title cost for a mandatory addition. This rate will always need to be provided by the Publisher.

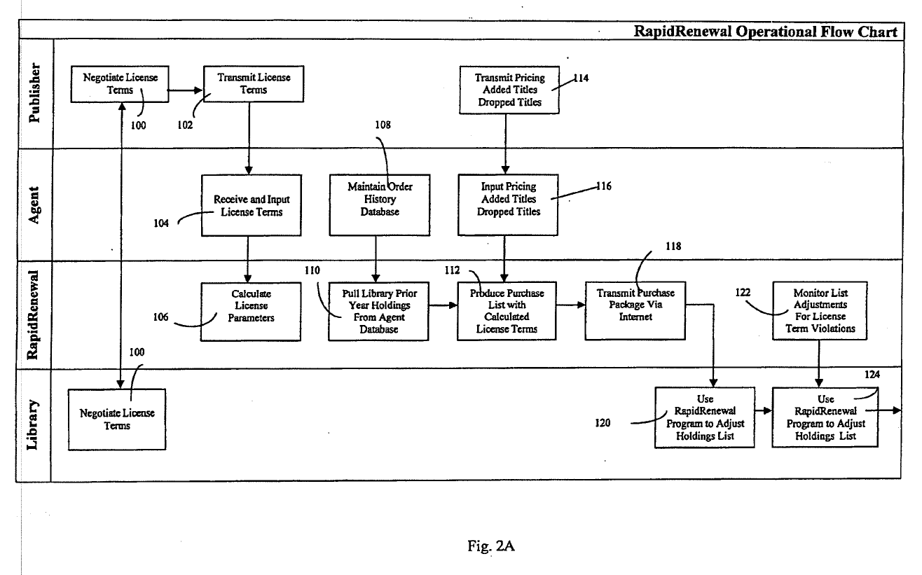

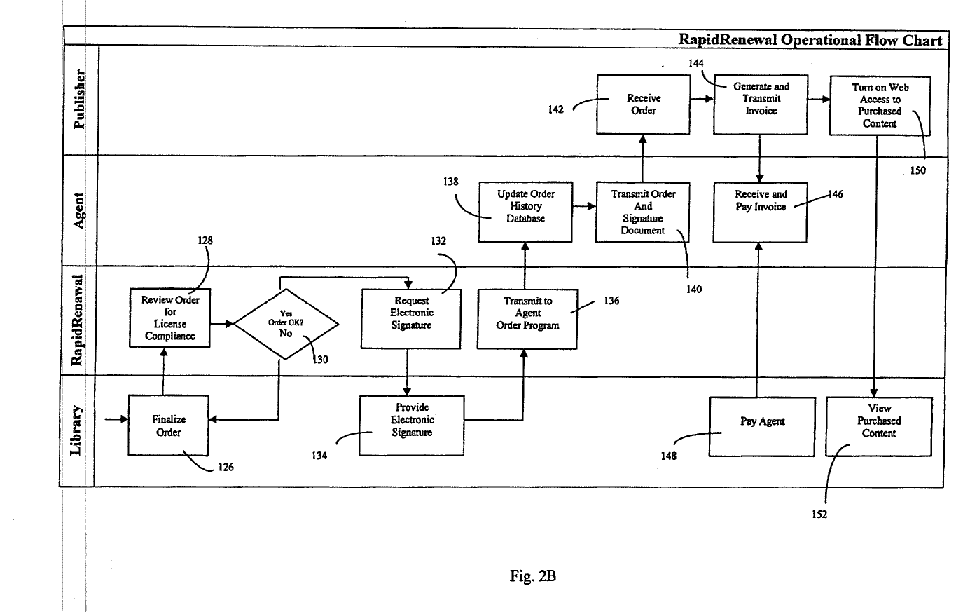

The main process for importing information into the Agent computer 12 is generally a three step process using a Publisher Data Import Engine maintained and operated by the Agent computer 12. For new Customers to the system, there will be an additional step that will need to be taken. For the actual import process, there are several factors that need to be taken into consideration. The following steps assume that the design will incorporate “pre-queues” or “temporary” queues before customer information is committed to the database maintained by the Agent computer, which is also referred to as the data warehouse. It is assumed that the import of the General Price List, Custom Price List, Customer Title List, and Add/Drop List will be imported from the Publisher computer 14 to the Agent computer 12 in separate spreadsheets or other files. During the import process, if there are key pieces of information missing, the line item should be moved to an exception queue so that it can be worked by an administrator of the Agent at a later time. If there is an exception in the import process, the process should continue after the item is entered into the exception queue. It is assumed from a data warehouse maintained by the Agent computer 12 that the Agent will be able to import the Journal Home Page URL and the Library of Congress Classification (“LCC”) by matching the JID and ISSN. FIGS. 3-4 provide diagrams describing the data flow of the “general import” into the Agent computer 12, or more specifically the import of the Add/Drop List (FIG. 3) and the New Year General Price List (FIGS. 4a and 4b).

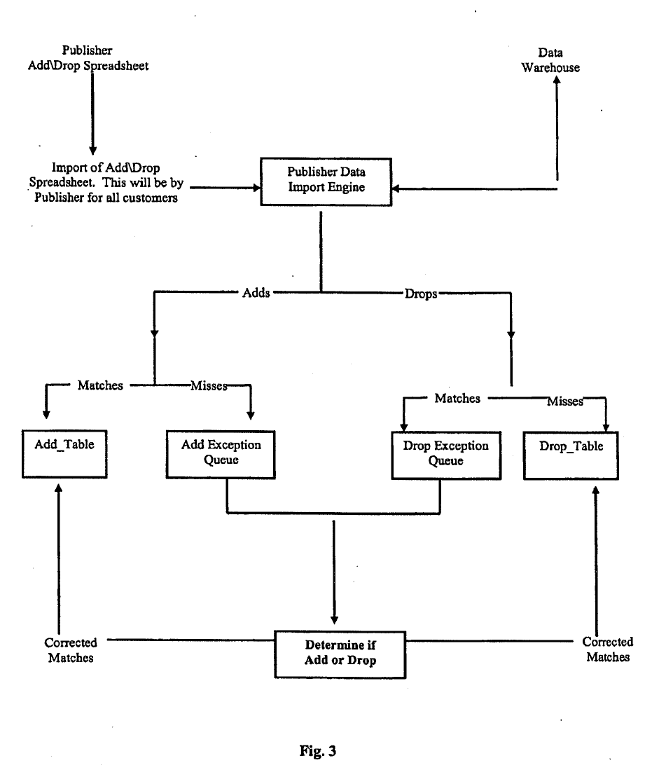

Looking to FIG. 5, the data flow of the “Year One Customer” import, or more specifically the import of the Customer Price List, is illustrated. In particular, the Publisher Data Engine of the Agent computer 12 is in communication with the Publisher computer 14 to import data into a temp-cust-holding-table maintained by the Agent computer 12. This connection may be an FTP connection or other electronic communication allowing the transmission of the file. The Account number used will be the office code and account number. Suffix & sub up code will be excluded in order to pick up all packages and components. The data warehouse has a cube with cells to maintain the data by Publisher Number and Account Number for all packages and components. This cube will have “cleansed” data where duplicates have been eliminated. That is, a compare will be done from the temp-cust-holding-table against data warehouse by Publisher Number and account number for JID and ISSN. All matches are moved to a cust-holding-table by Customer account number with package information from data warehouse. All misses or partial matches are moved to a Customer Price List Exception Queue. This will be for items from the Publisher that did not match to the data warehouse and items in the data warehouse that did not match the Publisher list. The Administrator with the Agent for Publisher Services will work the queue. Partial matches and corrected mismatches will be moved back to the cust-holding-table. All mismatches that do not apply (for whatever reason) will be cleared from the queue.

The Publisher Data Rules Engine software application and the underlying database model will be the “brains” of the network 10. This engine is a matrix type of rules engine that allows unique but programmable rules to be applied in the transfer of account information. Examples of such rules are the price cap for a particular Customer, the percentage royalty for a Publisher, and when a Customer can cancel a title or titles, with a further description of some of the rules described herein. The Publisher Data Rules Engine determines the rules to be applied by the Publisher at a Customer level to determine what information is accessible by the Customer and what information is provided by the Publisher. Within the Publisher Rules Engine, there will be various fields that are activated or deactivated via the Administration screen of the Agent computer 12 The Publisher Rules Engine will be unique according to the particular Publisher and Customer interacting with the Agent. The Publisher Rules Engines has the ability save the Publisher-Customer “profile” in the Agent computer 12 so that in setting up other Publisher's Customers that have the same rule sets, the Agent Administrator can simply choose a “profile” to apply to the new Publisher's Customers versus setting up a new rules set. Further, the Publisher Rules Engine needs to be a “real time” versus any type of batch process. The Customer queries need to be “real time” as they select different options.

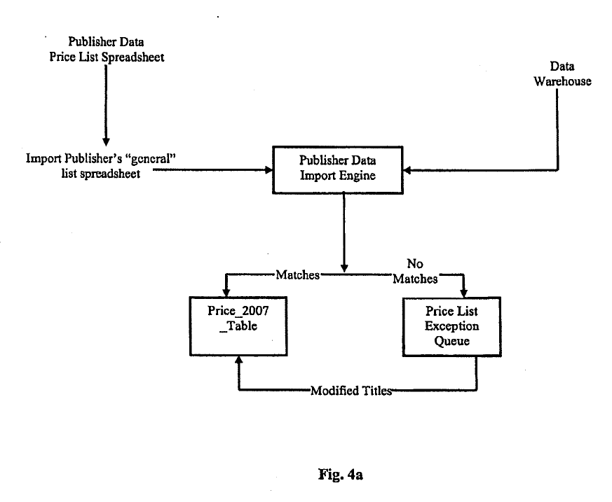

Looking to FIG. 6, a block diagram illustrates how the Publisher Rules Engine operates. That is, the Publisher Rules Engine operated by the Agent computer 12 has access to tables to be added or dropped, a pricelist table, Customer holding table for the previous year, and a temporary Customer holding table for the present year. A comparison will be performed by the Agent computer 12 according to the Account Number, JID and ISSN against the pricelist table, the add-table, the drop-table and the Customer holding table for the previous year. All matched data will be moved to the temporary Customer holding table for the present year.

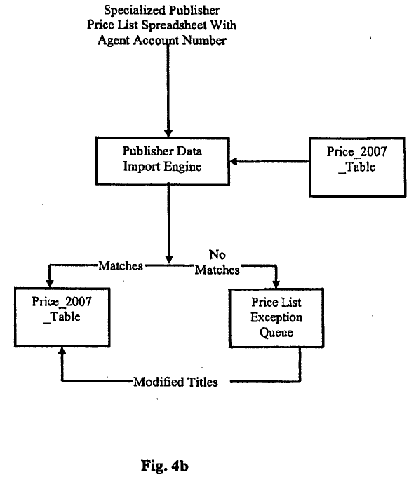

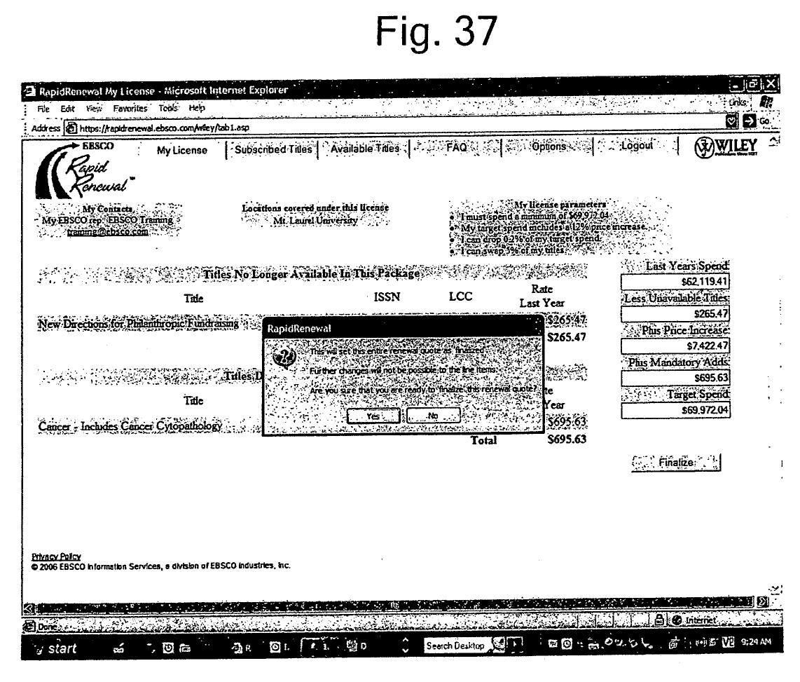

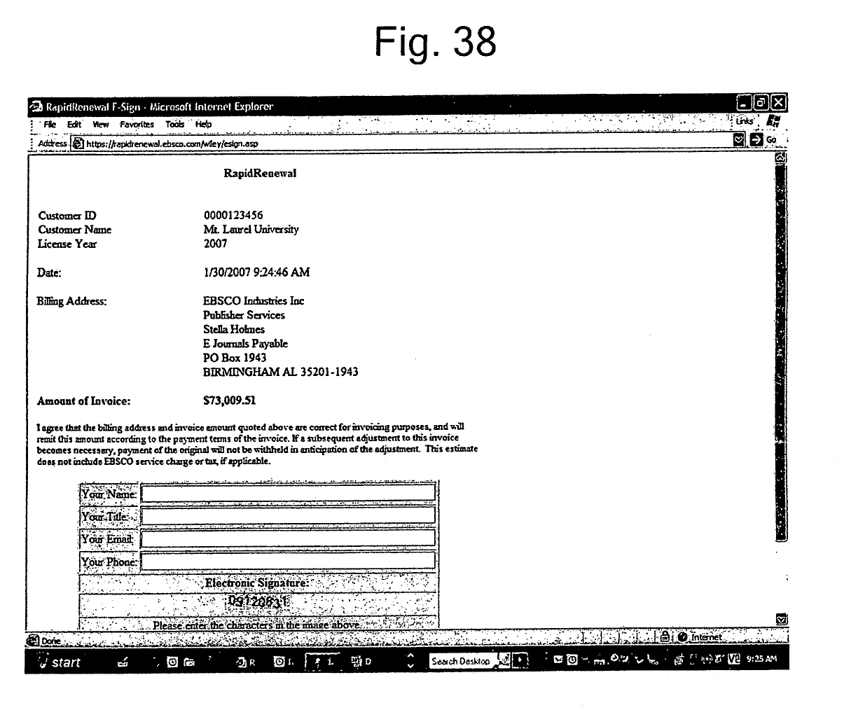

Referring to FIG. 7, the temporary Customer holding table will be utilized during the “adjustment” phase of the renewal process with the associated rules documented in the functional specifications based on the Customers actions. Once the Customer finalizes the renewal, the temporary Customer holding table will be committed or finalized and will become the Customer holding table for the present year. As shown in FIG. 37, the Customer will be prompted to confirm that the renewal will become final prior to entering the corresponding information. Once finalized, the Customer will provide their electronic signature as shown in FIG. 38.

The following various Data Fields should exist in the database but will need to be utilized by the Publisher Rules Engine. First, the Previous Year Spend Amount is one data field, and it is the amount that the Customer spent the previous year. This is the key field to all the rules and formulas that will be used by the Publisher Rules Engine. This amount will come from the database. However, the data in the database can be populated in two different manners. If it is a new Customer, the amount will be pulled from the database which was populated by the import of the Customer Title List spreadsheet via the Publisher Data Import Engine. If this is a previous Customer, the number will still be pulled from the database, but will be the previous years spend amount. A second field is the Unavailable Title Amount, which is the amount of the titles that the Customer subscribed to the previous year but that are not available in the current year. This amount will come from the database. The amount that is pulled from the database was populated by the import of the Add/Drop List spreadsheet via the Publisher Data Import Engine. A third filed is the Mandatory Title Amount, which is the amount of the titles that the Customer subscribed to the previous year from a different Publisher, but those journals were purchased and now owned by the current Publisher. Therefore, the Customer must continue their subscription with the new Publisher, and they are a mandatory title addition. This amount will come from the database. The amount that is pulled from the database was populated by the import of the Add/Drop List spreadsheet via the Publisher Data Import Engine.

In addition to the Data Fields mentioned above, the following Input Data Fields are the different fields that will need to be captured via the Administration page and stored in the database in order to be applied via the Publisher Rules Engine. The first Input Data Field is the Publisher Name, which should be pulled from the database based on what has been imported via the Publisher Data Import Engine. Second, the Customer Name field should be pulled from the database based on what has been imported via the Publisher Data Import Engine. The Price Increase (percentage) field corresponds to the percentage more that the client will spend than in the previous year. In many cases, Price Increase (percentage) is used interchangeably with Price Cap. One caveat with this item and the Price Increase (percentage) and Price Cap is that if the new year's price in the database is lower than the calculated Price Increase (percentage) or the Price Cap, the lower database price will need to be utilized. Another field is the Postage Field, which identifies whether the Customer will or will not be charged postage for their print journals based on their contract. This price will be contained in the database for each title and will be inputted into the database via the General Price List during the import via the Publisher Data Import Engine. It is noted that this field could simply be a check box. A Consortium Field is provided according to whether a consortium 17 is involved. That is, based on the Publisher Data Import Engine, either there will be consortium or not. However, via the Administration page by Publisher per Customer they will be able check the field if they belong to a consortium. Again, this field could simply be a check box. If the check box is selected, then the administrator will be able to select the consortium that the Customer belongs to via a drop down list based on what has been pulled into the data base via the Publisher Data Import Engine.

Another field is provided for Print Plus Online Fees, in which the Customer can have no Print Plus Online option, Dual Access, or Deeply Discount Print (DDP) or both. Thus, there should be four options: blank, DDP, DAY or both. If the box is checked then a percentage will be inputted via the Administration page by Customer on the Customer computer 16 for the different options selected. An additional field is the Drop Amount (percentage), in which each Customer is allowed to drop a certain percentage (cost wise) from their overall targeted spend amount. Likewise, a Swap Amount (percentage) field allows each Customer to swap a certain percentage (cost wise) from their overall targeted spend amount. Finally, a Multiplier is provided to allow the input of a multiplication factor. The multiplication factor is the average number of subscriptions per title held by the subscriber(s). It is calculated by dividing the combined number of subscriptions held by the subscriber(s) by the number of unique titles, and is identified in the license agreement. The default multiplication factor will be 1, and if per the Customer's contract the number is other than 1, then the number can be changed from the Administration page. In a second option, the multiplier can either apply to “adds” or “adds and swaps.”

The following are the formulas and rules that will need to be utilized by the Publisher Rules Engine with the data fields that are listed above based on the Publisher and the individual Customer. The engine is designed in such a way that, as new Publishers and Customers become part of the system 10, the rules or options to existing rules can be added without rewriting or re-factoring the system 10. The Publisher Rules Engine is also designed in such a way that an Administrator can make the rules adjustment without involving development staff. That is, the Publisher Rules Engine will have a table of variables that can easily be adjusted as desired by the Administrator.

The Administration page is for internal use only on the Agent computer 12 by the authorized Agent. This page has two main functions. The first function is to be used for and only by the Administrator established by the Agent. The Administration page generated by the Agent computer 12 will be the location for all the preference settings for the Publisher Data Import Engine and the Publisher Rules Engine. The second function of this page will be for the Agent or Publisher Services to “finalize” a Customer's renewal effort.

In operation, this page with have a panel that gives a detailed explanation of the functionality of each page. It will follow all the requirements for the General Site Design and Common Section Page Elements described above. Access to this page will be restricted to persons authorized by the Agent. There will be a query function on this page for either the Administrator or other members of the Agent. This query will either be by Publisher or by Customer. If by Publisher, it will display the following: (1) the Customers that have been loaded into the system for that Publisher; and (2) the status of the Customer as to whether they have renewed or not. If by Customer, the webpage will display the following: (1) the Publishers that have been loaded for the Customer; and (2) the status of the Customer's renewal for each Publisher.

Generally, there will be two “types” of employees of the Agent that will have access to this page. The first is the Publisher Services Administrator, or the person(s) that will be responsible for setting up the Publisher and Customer “preferences” for the Publisher Data Import Engine and the Publisher Rules Engine. This person will also be responsible for the “import” process. This person will also have access to the “finalization” section for a Customer's renewal. The second is the Agent Office Administrator, who will have access to this page to review the final renewal of a Customer and the “finalize” the order. From this section the Office Administrator can also “adjust” the Customer order before “finalizing” the order.

The web page will have a Preference Section that will be the location of the application where the Publisher Services Administrator can set the individual preferences for each Publisher and the associated Customer for the Publisher Data Import Engine and the Publisher Rules Engine. Various Input Data Fields or “preferences” will need to be captured via the Administration page and stored in the database in order to be applied via the Publisher Rules Engine. The Input Data Fields include the Publisher Name, which should be pulled from the database based on what has been imported via the Publisher Data Import Engine and the Customer Name, which should be pulled from the database based on what has been imported via the Publisher Data Import Engine. The Agent Office that would be responsible for the Customer in question and would be in charge of reviewing and finalizing the Customers order should also be captured, and this list should be pulled from the database. The email address of the office should be pre-filled from the database, but there will also be a CC field that the Publisher Services Administrator can key in a secondary address that will be used as a “carbon copy” field.

The Input Data Fields should also include a Price List For Calculation. That is, most Publishers calculate everything off the Custom Price List per independent Customer for all base calculations. However, some Publishers base the calculations of the General Price List (“Any” account number). It should also include a Price List For Adds/Swaps, wherein most Publishers calculate everything off the Custom Price List per Customer for all Adds/Swaps. However, some Publishers base the Adds/Swaps calculations of the General Price List. The Price Increase (percentage) should be included. That is, each Customer is required by contract to spend a percentage more each year than the previous year (referred to as the Price Increase Rule). In many cases, Price Increase (percentage) is used interchangeably with Price Cap. One caveat with this item and the Price Increase (percentage) and Price Cap is that if the new year's price in the database is lower than the calculated Price Increase (percentage) or the Price Cap, the lower database price will need to be utilized. The Postage Field should be included, in that either the Customer will be charged postage for their print journals or they will not based on their contract. This price will be contained in the database for each title and will be inputted into the database via the Price List during the import via the Publisher Data Import Engine, and the Field should be a check box. A Consortium Field should be included to indicate if there will be consortium or not. However, via the Administration page by Publisher per Customer they will be able check the field if they belong to a consortium. This field should be a check box, so that if the check box is selected then the administrator will be able to select the consortium that they belong to via a drop down list based on what has been pulled into the data base via the Publisher Data Import Engine.

The Input Data Fields will additionally include Print Plus Online Fees, which is a fee that is charged to the Customer for having both online and print titles without paying full price for both titles. As noted above, there are two methods of fees that can be applied; the “Dual Access Fee,” which is a percent of the online cost, or the DDP, which is a percent of the print cost. Usually one or the other method would apply to the Customer via the Publisher but there will be cases that both options will apply to the Customer from the Publisher on different titles. This field should be a check box for either Dual Access or DDP or both. If blank, the Print Plus Online Fees do not apply to the Publisher or Customer. If the box is checked, then a percentage will be inputted for each of the options (Dual Access or DDP or both).

Another input field is the Drop Amount (percentage) in which each Customer is allowed to drop a certain percentage (cost wise) from their overall targeted spend amount. A Swap Amount (percentage), wherein each Customer is allowed to swap a certain percentage (cost wise) from their overall targeted spend amount is also provided. Finally, a Multiplier is included in the Input Fields, with the multiplication factor being the average number of subscriptions per title held by the subscriber(s). It is calculated by dividing the combined number of subscriptions held by the subscriber(s) by the number of unique titles. This factor is identified in the license agreement between the Customer and the Publisher. In general, the default will be 1 and will be changed if necessary according the contract. A second option is that the multiplier can either apply to “adds” or “adds and swaps.”

With respect to the Import Process, the Publisher Services Administrator will have the ability to start an import process for a particular Publisher and corresponding Customers. From this section, the Publisher Services Administrator on the Agent computer 12 will need to be able to select the file to be imported. That is, select the Publisher for the associated file and execute the import of that file from a particular location. During the import process, if there are key pieces of information missing, the line item should be moved to an exception queue so that it can be worked by a Publisher Services Administrator at a later time. If there is an exception in the import process, the process should continue after the item is entered into the exception queue. Once the import has completed, the second step of the import process should be for the Publisher Services Administrator to clear the import exception queue. At any point during this process, the Publisher Services Administrator should have the ability to manually modify any data in the pre-queue. An Audit History data file should be maintained in the Agent computer 12 for all changes to the renewal order made in the Exception Queue. The Audit History should contain the history of who made a change, what was changed (to and from) and when it was changed. Once the Publisher Services Administrator is satisfied with the state of the data in the pre-queue, it will have the ability to “commit” the data to the database.

Once the renewal has been finalized by the Customer, an email notification is automatically generated by the Agent computer 12 and sent to the Agent's support office for that respective Customer. There will be a queue associated with each office and in this queue the Customer renewal will be placed once the Customer has finalized the renewal. The responsible Agent office employee will then sign into the system and from this queue, will have the ability to review the submitted renewal order from the Customer. The Agent office employee will have the ability to modify any of the information within the renewal order. Once the renewal order has been reviewed and completed, then the renewal order will be “finalized” by the Customer, and the corresponding information will be sent to the mainframe 12 Order Entry system for a corresponding data entry to be saved and maintained by the Agent computer 12. The Agent offices will only have access to their associated Finalization Queues, but the Publisher Services Administrator will have access to all the Finalization Queues.

An Audit History or Transaction Log must be maintained in the Agent computer 12 for all changes to the renewal order made in the Finalization Queue. This Audit History or Transaction Log must contain the history of who made a change, what was changed (to and from), and when it was changed. The Agent's office and/or the Publisher Services Administrator must have the ability to “reset” a finalized order. In other words, a Customer that has finalized an order and the Agent office has finalized the order, however, an issue is detected where either the Agent office or the Customer needs to either adjust the finalized the order or start over completely. The option should allow the Agent office or the Publisher Services Administrator to put the renewal in a “un-finalized state” so the renewal can be modified and “re-finalized” or reset the entire order back where it was at the beginning so that the Customer go back through the process.

The Home page will be the general entry point to the application for Customers as displayed on the Customer computer 16. From this screen a Customer will be able to navigate to any other area of the application. This page with have a panel that gives a detailed explanation of the pages' functionality, and will follow all of the requirements for the pages listed above. This page will contain panels of information about each of the underlying areas of the application with links to those areas. Since the Customer could potentially visit the site in order to renew an order for two or more different Publishers, the Customer will not be allowed to link to the License Page, Adjustments Page or Available Titles Page until they have selected there Publisher and account on the Preference page. If the Customer tries to link to one of these sites without first selecting the Publisher and package that they would to work on, they will be presented a message stating such. Once this is done, the Customer can link to any link from the Home page. This page will contain a news panel that will show general news for all Publishers that were posted by Publisher Services. The Administration page will not appear for a Customer.

The Preferences page is the common page for the setup of all the preferences within the application. From this section/page, a Customer can manage all the settings for the application. The Preference Page will have a panel that gives a detailed explanation of the pages' functionality. This page will follow all the requirements for the other pages listed above, and will contain account information about the different accounts and Publishers that the Customer has authorization to access. From this panel, the Customer will first select the Publisher. This will be a drop down list based on the database. Once the Publisher is selected, they will then need to select the package want to work on. This will be a drop down list based on the database. Once these options have been selected, a list of sites covered by the account will be displayed on the page. This page will have a panel for the customization of the application, which could include the ability to change screen and panel colors, a field to select font size throughout the application, and the number of records to be displayed per page. This page will have a panel to allow the changing of password, and a panel to allow the input of the Customer's email address in order for the Customer to receive e-mail confirmations of their renewals.

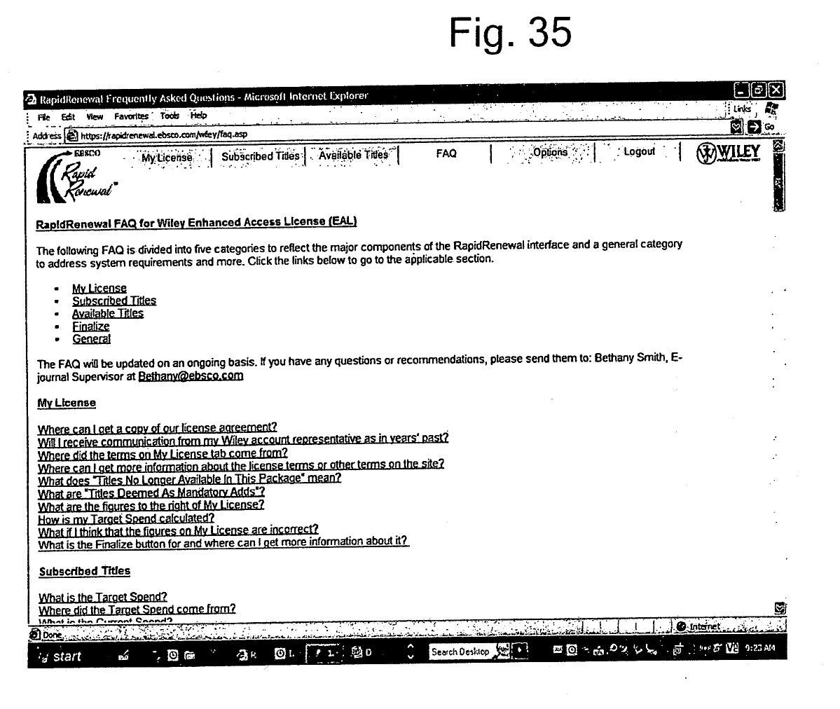

The License Information page is the “base” page of the application, and it is illustrated in FIG. 35. It is from this page that the Customer will see a “snap shot” of their entire license on the Customer computer 16. This page with have a panel that gives a detailed explanation of the functionality of the pages and will follow all the requirements for General Site Design for the web pages listed above. The Customer name and account number, which are selected and defined via the Preference page, will be displayed in the top section of the screen. The license parameters will be displayed in a panel in the top section of the screen. These parameters will be per what was defined by the Publisher Services Administrator on the Administration page. The list of the license parameters that will be displayed include the Original target Spend, Actual Price Increase, Swap Amount, Drop Amount, Current Target Spend, Fees, and Current Year Total Spent. The Original Target Spend (Original Calculation) is a number that needs to be a link that will allow you to drill down in the number. If the Customer drills down, they should see a “quasi” report showing the calculations that made up the Target Spend. The Original Target Spend includes the Last year spent minus Unavailable Titles plus Actual Price Increase plus Mandatory Titles. This report should not change; it is the starting point of all calculations. The Actual Price Increase (Calculation) needs to be a link that will allow you to drill down in the number. If the Customer drills down, they should see a “quasi” report showing the calculations that made up the actual price increase. The Actual Price Increase equals Last years pricing multiplied by the price increase compared to this years list and the lower amount accepted minus last year's price. The Actual Price Increase will be a changing number due to Swaps and Drops and should change as Swaps and Drops are made.

The Swap and Drop Amounts show the percentage (Preference) and amount (Calculation). The Current Target Spend is calculated taking into account the change in Actual Price Increase due to Drops or Swaps. This number needs to be a link that will allow you to drill down in the number. If the Customer drills down, they should see a “quasi” report showing the calculations that make up the Current Target Spend. The Current Target Spend is calculated using Last year spent minus Unavailable Titles plus Actual Price Increase plus Mandatory Titles. This will be a changing number due to Swaps and Drops and the impact to Actual Price Increase and should change as Swaps and Drops are made. The Fees (Calculation) will be a combination of Postage, DDP and Dual Access Fees. If the Customer drills down, they should see a “quasi” report showing the calculations that make up the Fees. This will be a changing number due to Additions, DDP and Dual Access adjustments. Finally, the Current Year Total Spent will be a combination of Print cost, Online Costs, Postage Costs, DDP Fees and Dual Access Fees. This number needs to be a link that will allow you to drill down in the number. If the Customer drills down, they should see a “quasi” report showing the calculations that make up the Current Year Total Spent. This will be a changing number due to Swaps, Drops, Additions, Postage and DDP and Dual Access Fees and should change and changes are made.

There will be three main sections to the License Information page. The first section will be Unavailable Titles. The fields that will be represented on the user interface will be: Title, ISSN, LCC, and Rate—Last Year (if available). The second section will be Mandatory Titles. The fields that will be represented on the user interface will be: Title, ISSN (This will be a link to the Publisher's journal home page), LCC, and Rate—This Year. The third section will be Subscribed Titles. The fields that will be represented on the user interface will be Title, ISSN (this will be a link to the Publisher's journal home page), LCC, Rate—This Year, and Rate—Last Year.

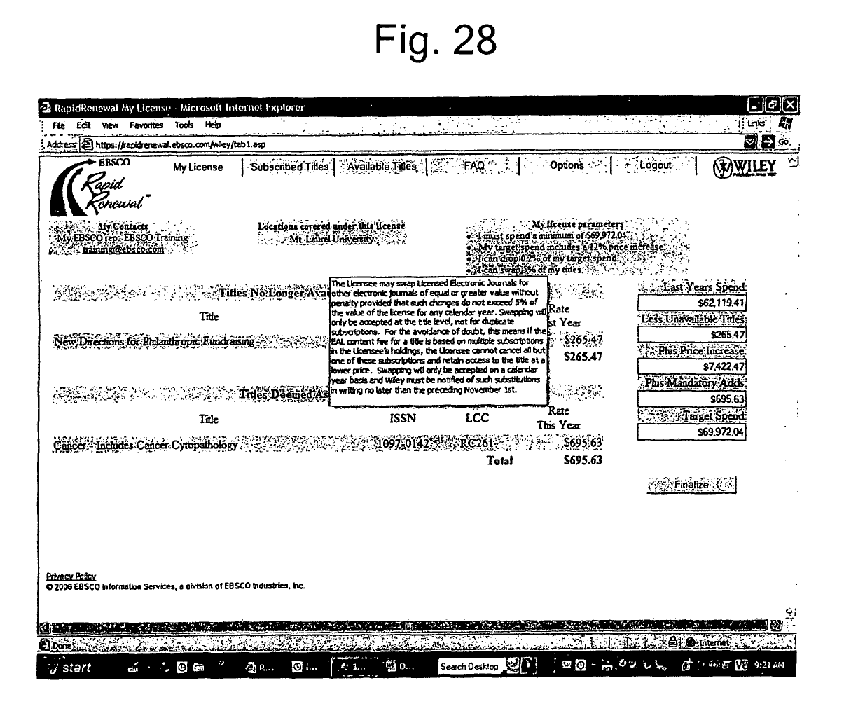

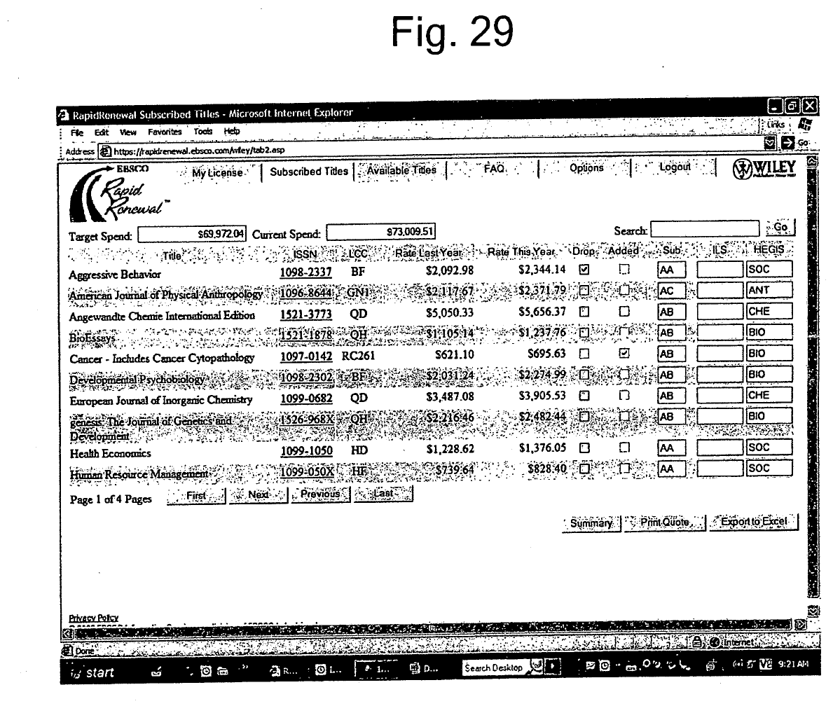

There will be a “finalize” and a “reset” button at the bottom of the user interface. The finalize button will allow the Customer to commit the changes and make them final. The reset button is to discard all changes that have been made and to allow the Customer to start over again. The reset button should not work after the order has been finalized. Once the Customer finalizes the order by selecting the corresponding button on the website (see FIGS. 27 and 28), the Agent computer 12 will automatically prepare and send an e-mail to the Agent office to notify them that a renewal order is ready to be reviewed and approved. Once a renewal order is finalized by a Customer, they will not be allowed to adjust that order again. There will be a “Print” and “Export” button at the bottom of the user interface (see FIG. 29). The Print button will allow the Customer to print their “invoice” once they have finalized the renewal. The Print button should not work until the order has been finalized. The Export button will allow the Customer to export their “invoice” to a program, such as Excel. The export button should work at any point during the process.

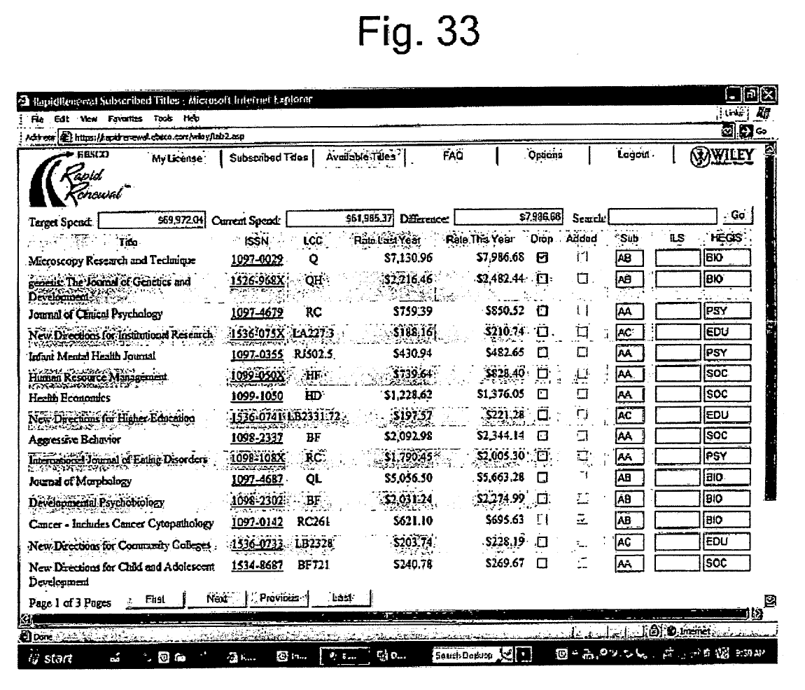

Another page generated by the system is the Adjustments page (see FIG. 33), which will be the location for the Customer to handle all Swaps, Drops, Print Plus Online and Additions. This page with have a panel that gives a detailed explanation of the functionality of the pages, and will follow all the requirements listed above for General Site Design and Common Section/page Elements. The Customer name and account number will be displayed in the top section of the screen. The Customer name and account number are selected and defined via the Preference page. There will be four main links on this page with verbiage explaining each one. Each link will take you to a “sub” page that will not be present on the tabs, left gutter or the home page. The four sections are Drops, Swaps, Print Plus Online, and Additions.

For Drops, there will be verbiage that will be provided by Publisher Services about the rules related to dropping titles. The calculated drop amount will also be shown next to the explanation. This calculation will constantly update based on the selections that the Customer makes in that section. The next area will show all the titles that the Customer can drop based on the amount. For example, if the drop amount is $1,000, the list of titles that will appear would be any titles the Customer subscribes to that are $1,000 or less. For each title, the following five fields will be displayed Title, ISSN (this will be a link to the Publisher's journal home page), LCC, Rate—This Year, and Drop Box. This will be the box that they will check if they want to drop the title. As the Customer selects titles (could be multiple titles) to reach the drop amount, the drop amount at the top of the screen will change. Once the drop amount is at zero, the user/Customer should not be allowed to select any addition titles that will put them over the drop amount.

For Swaps, there will be verbiage on the Adjustments Page that will be provided by Publisher Services about the rules related to swapping titles. The calculated swap amount will also be shown next to the explanation. This calculation will constantly update based on the selections that the Customer makes in that section. This calculation or figures will be in two parts; the first figure being the amount that can be dropped as part of the swap and the second figure (which will start at zero) will be the additions that need to be made in comparison to the drops in the swap. For example, if the swap amount is $1,000 and the Customer drops a title worth $100, the swap/drop calculation would go down to $900 and the swap/add would go from $0 to $100. The next area will show all the titles that the Customer can drop based on the amount. For example, if the drop amount is $1,000, the list of titles that will appear would be any titles the Customer subscribes to that are $1,000 or less. For each title, the following fields will be displayed: Title, ISSN, LCC, Rate—This Year, and Drop Box. This will be the box that they will check if they want to drop the title. As the Customer selects titles (could be multiple titles) to reach their drop amount, the drop amount at the top of the screen will change. Once the drop amount is at zero, the Customer should not be allow to select any addition titles that will put them over the drop amount.

The next area of the Adjustments Page will show all the titles that the Customer can add. These essentially would be all available titles since there is no limit on the amount of swap/add that can be done as long as they reach their swap/add minimum. For each title, the following fields will be displayed: Title, ISSN, LCC, Rate—This Year, and Add Box. The Add Box will be the box that the Customer will check if a title is to be added. As the Customer selects titles (could be multiple titles) to reach their add amount, the add amount at the top of the screen will change.

For Print Plus Online, there will be verbiage that will be provided by Publisher Services about the rules related to Print Plus Online. This section will be for removing Print Plus Online from current titles or adding Print Plus Online to new titles, as well as for both Deeply Discount Print and Dual Access. For new Customers, part of the initial import of the Customer Title List will indicate whether a Customer has Print Plus Online on a title and the format. For the second year, this information will be pulled from the database. Current titles (either online or print) but are not Print Plus Online titles for that Customer. Via the Price List import, titles will be flagged if they are Pint Plus Online and if so the method (DDP or Dual Access) that follow. When the Customer enters this section of the page, they will be presented with two options. The first option is to remove Print Plus Online from a current subscribed titles. The Customer only is allowed to remove the Print Plus Online option. If they want to Drop the title, they will need to go to the Drop section of the application. The following fields will be displayed: Title, ISSN, LCC, Rate—This Year, DDP or Dual Access (DA) code, a rate box showing the cost of the DDP or DA, and a drop box to remove this title's DDP or DA. The second option is to add Print Plus Online line to currently subscribed titles. The Customer will be shown all the titles that they currently subscribe to that have a Print Plus Online option but that currently don't have that option selected. The following fields will be displayed: Title, ISSN, LCC, Rate—This Year, DDP or Dual Access (DA) code, a rate box showing the cost of the DDP or DA, and an add box to add DDP or DA to this subscribed title. On the page, there will be two calculation boxes, one titled DDP Fees and the other DA Fees. As Print Plus Online options are add or dropped the calculations in the boxes will adjust accordingly.

For Additions, there will be verbiage that will be provided by Publisher Services about the rules related to Additions. This section will be for adding new titles to the Customer's renewal order. There should be four boxes at the top that shows the cost of the Additions, Postage, DDP and Dual Access Fees for each addition made within the section. The multiplier per the Administrative parameter should also be shown with the boxes above. The Customer will be presented with all available titles for the Customer's package that they do not currently subscribe to at that time. The following fields will be displayed: Title, ISSN, LCC, Rate—This Year, Postage Rate, DDP or Dual Access (DA) code (if no code, then DDP or DA does not apply to this title), a rate box showing the cost of the DDP or DA, and an add box for Print Only, Online Only or DDP/DA

On the main page, there will be a “Save” button in order to save all the changes that were made in the Drop, Swap, Print Plus Online and Additions Section.

An additional page is a “Frequently Asked Questions”. This page with have a panel that gives a detailed explanation of the pages' functionality. This page will follow all the requirements listed above for General Site Design and Common Section/Page Elements. This page will be comprised of links of frequently asked questions. The link of each question will take the Customer to a detailed explanation of the question. For a majority of this, Publisher Services will “reuse” the FAQ's from earlier versions. There will need to be some additional information added for issues or explanations of the new system, and all this information will be provided by Publisher Services.

Example of Calculations Performed by the System

The following example is provided to illustrate the rules applied by the Agent computer 12. The following values will be used for the examples with each rule and it is assumed that the current year is 2006 and the Customer is renewing for 2007. For the example, assume that the Previous Year Spend Amount (2006) is $1,000. This will either come from the previous year's numbers in the database for a returning Customer or from the database via the Customer Title List and the Publisher Data Import Engine function for new Customers. The Unavailable Title Amount (2007) is $200. This number will come from the database via the Add/Drop List and the Publisher Data Import Engine function. The Mandatory Title Amount (2007) is $100, which will come from the database via the Add/Drop List and the Publisher Data Import Engine function. The Price Increase (2007) is 5%, which will be inputted for the “new year” (2007) via the Administration page by the Publisher Services Administrator. The Postage Fee (2007) is $10 (although this cost will vary by title). The source of this amount will come from the database via the Price List and the Publisher Data Import Engine function. The Dual Access Fee (percentage) (2007) is inputted for the “new year” (2007) via the Administration page by the Publisher Services Administrator and set at 10%. Likewise, the Deeply Discount Print (DDP) (percentage) (2007) of 25% will be inputted for the “new year” (2007) via the Administration page by the Publisher Services Administrator. The Drop Amount (2007) percentage is set at 2%, which will be inputted for the “new year” (2007) via the Administration page by the Publisher Services Administrator. The Swap Amount (2007) is set at 5%, and will be inputted for the “new year” (2007) via the Administration page by the Publisher Services Administrator. The Multiplier (2007) is set at 2 via input for the “new year” (2007) entered via the Administration page by the Publisher Services Administrator. The title cost that will be added (2007) is $4 (Both Print or Online cost), while the title cost that will be dropped (2007) is $1.50.

The Price Increase for 2007 is equivalent to the (Previous Year Spend Amount minus Unavailable Title Amount) times Price Increase. For example, ($1,000−$200)×5%=$40. The rule for the Price Increase for 2007 is that in most cases, the flat rate increase, such as the one used above in the example, will be sufficient. However, the 5% increase is per title. This means that when the Customer's profile is entered via the Administration page and then committed to the database, the system will need to take the Price Increase (5% in this case) and run a calculation against the General Price List for each title held by the Customer. The system should take the lowest amount and apply that amount to the Customer's database for that title. The system should then store the actual increase amount for use by other formulas. An example of this rule is when the Customer holds one title which cost $100 for 2006. The calculated increase for 2007 is 5% or $105. However, the 2007 title General Price List shows that the Customer's title is $103 for 2007. The system would use the $103 price as the figure in the Customer's database for that title. The amount of $3 would be stored for the Price Increase value for 2007 to be used by other formulas. The Price Increase for 2007 does not apply to title additions or swaps during the new year.

The formula for the Target Spend for 2007 is the Previous Year Spend Amount minus the Unavailable Title Amount plus the Price Increase plus the Mandatory Title Amount. As an example, $1,000−$200+$40+$100=$940 (the Target Spend for 2007). The exception for the above formula is for the Price Increase (please see Price Increase Rule). In the examples used in this document the Price Increase for 2007 is 5% or $40. But the actual number used should be based on the Price Increase results. The Target Spend does not include any fees such as Print Plus Online Fee (Dual Access Fee & DDP) or Postage fees. The Drop Amount for 2007 1 is calculated by taking the Target Spend and multiplying it by the prior Drop Amount to obtain the Drop Amount for 2007. Using the example number, the calculation would be $940×2%=$18.80. The Swap Amount for 2007 is equal to the Target Spend×Swap Amount. For example, $940×5%=$47.00. The Title Cost for adding a new 2007 title is the Title Cost for 2007 times the Multiplier. For example, $4×2=$8.

The Print Plus Online Fee for 2007 can be calculated in two ways. The first is via Dual Access Fee and the second is Deeply Discount Print or DDP. Some Publishers implement both methods on a single Customer in a single year. Using the Dual Access Fee, the formula is Title Cost for 2007 (not the reduced cost if it falls under the Price Increase Rule) times Dual Access Fee equals the Dual Access Fee for 2007. For example, $4×10%=$0.40.

If the Customer database shows that the respective customer subscribes to a Print Plus Online title and the rule is checked via the Administration page, then this fee must be calculated and charged. For drops or swaps of Print Plus Online titles, the fee must be dropped. The title cost that is used for this calculation is the standard online cost from the General Price List for the new year or in this case 2007. Do not use the cost of the journal from the Custom Price List if this particular title falls under the Price Increase. This fee would not be part of the Target Spend amount. This fee will be listed under “fees” on the License page. Deeply Discount Print (DDP)—Title Cost for 2007 (not the reduced cost if it falls under the Price Increase Rule) times the DDP Fee equals the DDP Fee for 2007. For example, $4×25%=$1. Per the Customer database, if it shows that the Customer subscribes to a Print Plus Online title and the rule is checked via the Administration page, then this fee must be calculated and charge. For drops or swaps of Print Plus Online titles, the fee must be dropped. The title cost that is used for this calculation is the standard print cost for the new year or in this case 2007. Do not use the reduced cost of the journal if this particular title falls under the Price Increase Rule. This fee would not be part of the Target Spend amount. This fee will be listed under “fees” on the License page.

There is no calculation for the Postage fee for 2007. The amount is listed for each title in the current year title database. Per the Customer database, if it shows that they receive a print journal and the rule is checked via the Administration page, then this fee must be charged. This would also apply to new titles that are added. For drops or swaps of print journals, the fee must be dropped. This fee would not be part of the Target Spend amount. This fee will be listed under “fees” on the License page.

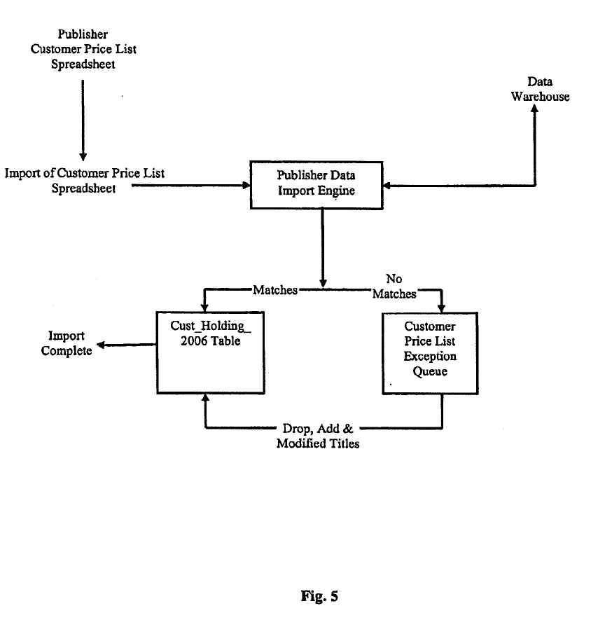

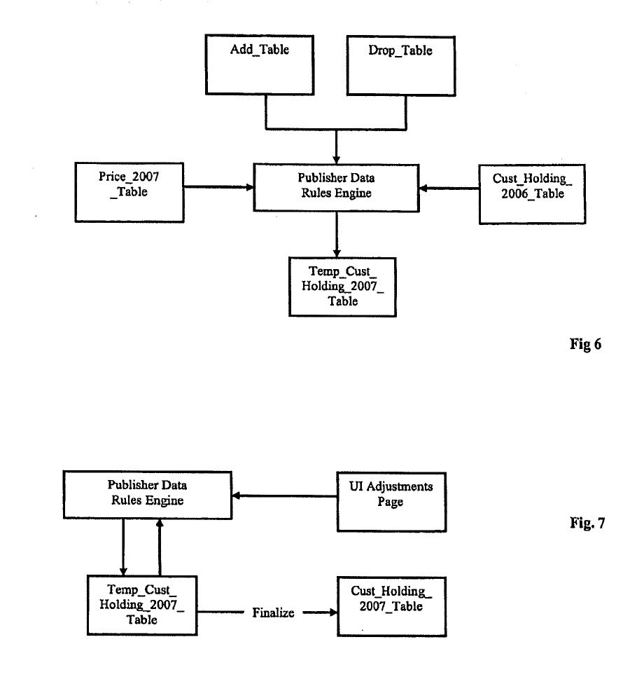

Looking to FIG. 8, a table is illustrated showing examples of the different calculations. This example is using the assumption that the Custom Price List is the default for all examples. The following is an example of calculating a price increase (5%) and postage. The table in FIG. 8 is the library's 2006 title list showing the costs, postage, and whether the titles are in print, online, or both for the library. The table of FIG. 9 is the Publisher's 2007 Price List for the titles that the library current holds.

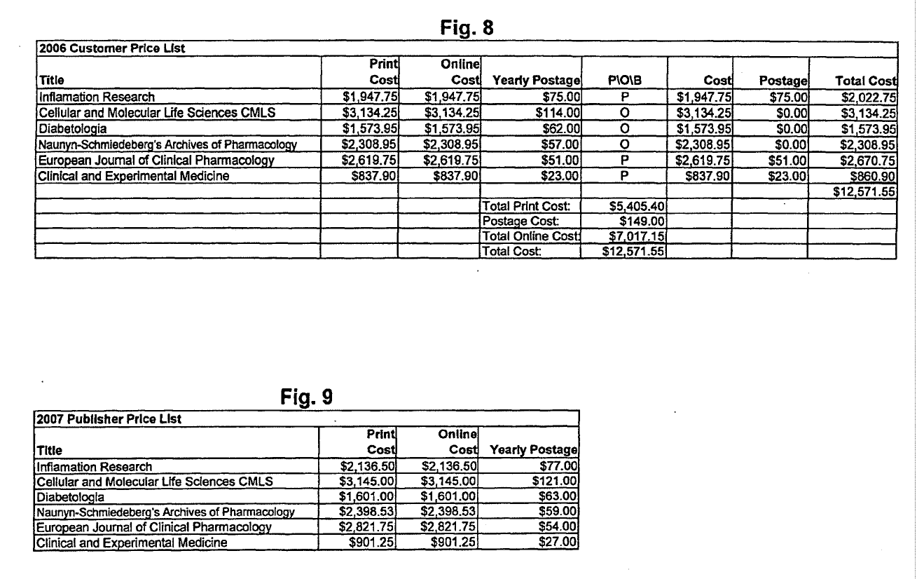

Referring to FIG. 10, the first step is to first step is to compare the 2006 cost to the 2007 General Price List in order to calculate the price increase. By contract, the increase will be “capped” at 5% (in this example, the actual percentage could be any number). In order to calculate the true price increase, the system must compare the 2006 prices with a 5% increase to the 2007 prices. The Customer will pay the lesser of the two prices. The resulting difference of the Actual 2007 cost to the 2006 cost will be the Actual Price Increase.

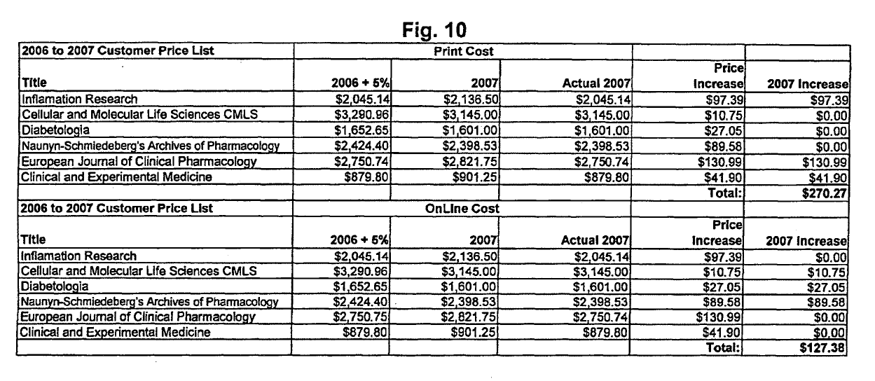

The table in FIG. 10 shows this comparison for both the print and online subscriptions. The chart in FIG. 11 shows the new final 2007 title list, in which the new prices are from the chart of FIG. 9 and postage only applies to the print titles that the library takes. The Actual Price Increase is calculated from the chart in FIG. 9 (which is lower than the 5% cap), but the 5% cap is shown below for comparison purposes.

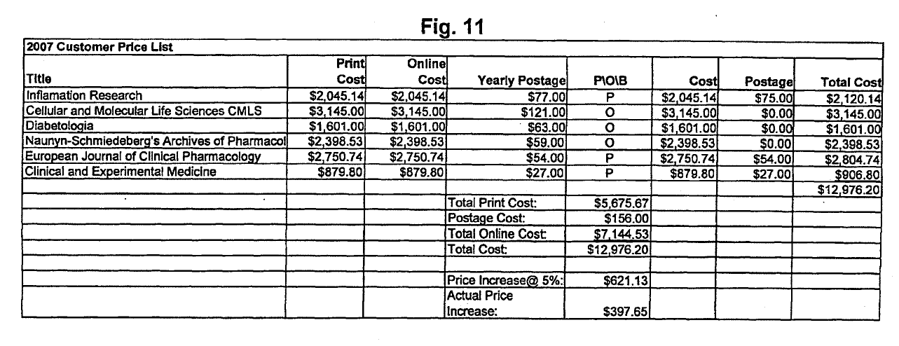

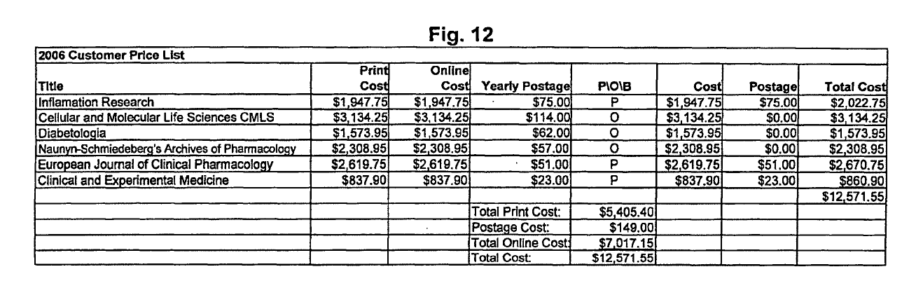

The following is an example of calculating Unavailable Title, Mandatory Title, and Target Spend. As defined earlier, the Unavailable Title is a title that the library subscribed to in the previous year, but has been sold by the Publisher and will not be available in the current year from the current Publisher. The Mandatory Title is a title that the library subscribed to in the previous year, but from a different Publisher. This title was sold to the current Publisher and therefore the client is required by contract to subscribe the title from the (new) current Publisher. The Target Spend is the previous year's cost minus unavailable titles plus Actual Price Increase plus Mandatory Titles. Postage or any other fees are not part of the formula. Target Spend is a critical number because numerous other calculations are based on Target Spend. Looking to FIG. 12, the library's 2006 title list showing the costs, postage and whether the titles are print, online or both for the library. The table in FIG. 13 is the 2007 Publisher Price List. Notice that European Journal of Clinical Pharmacology is crossed out because this is an Unavailable Title. It was sold to another Publisher during the year. Notice that the Asian Journal of Clinical Pharmacology has been added as a Mandatory Title. This was a title that was subscribed to by the library from another Publisher. The previous year's Publisher sold it to the current Publisher, so by the library's contract they must subscribe to the title from the current Publisher.

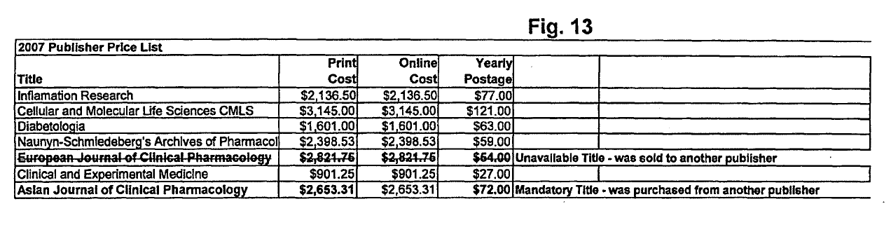

The table shown in FIG. 14 is the 2006 to 2007 title comparison list in order to calculate the Actual 2007 price and Actual 2007 Price Increase. Notice that the Unavailable Title has been removed from the list and the Mandatory Title has been added. Additionally, Unavailable Title does not come into consideration for the Actual Price Increase calculation.

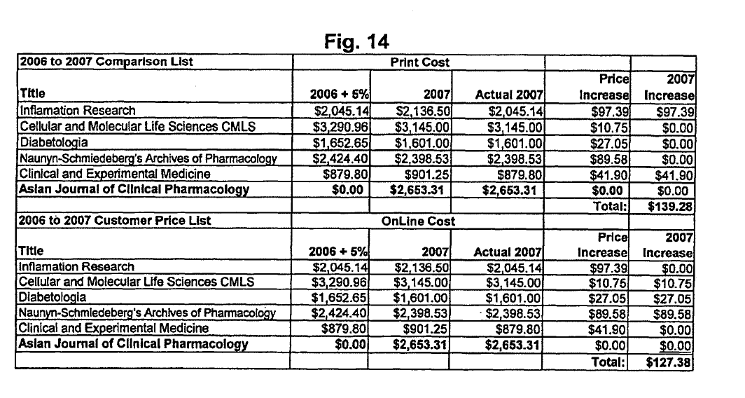

The table in FIG. 15 shows the new final 2007 title list. The Unavailable Titles does not appear in this chart and the Mandatory Title is listed. Notice that the new prices are from the chart above and that postage only applies to the print titles that the library takes. The Actual Price Increase is calculated from the chart above (which is lower that the 5% cap), but the 5% cap is shown below for comparison purposes. The Target Spend is calculated using the 2006 cost ($12,422.55) minus the Unavailable Title (European Journal of Clinical Pharmacology—$2,619.75) plus the 2007 Actual Price Increase ($266.66) plus the Mandatory Title (Asian Journal of Clinical Pharmacology—$2,653.31).

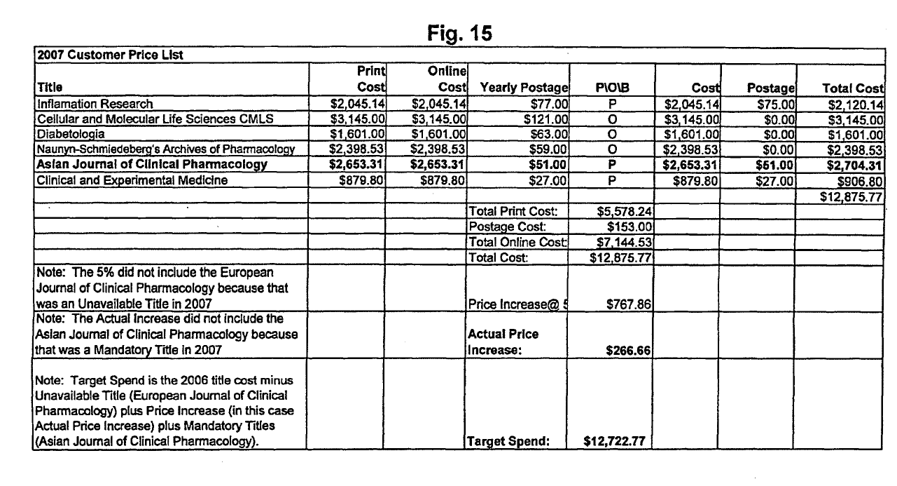

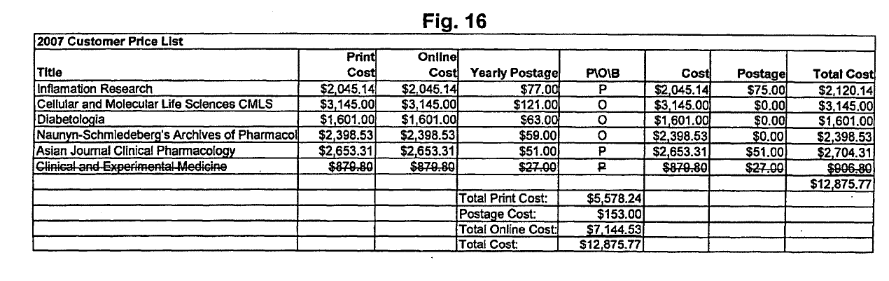

The following is an example of calculating Dropped Titles. For calculating dropped titles, the Actual Price Increase and the Target Spend calculations must already be completed and the dropped title would come from the new 2007 Customer Price List. A Customer such as a library can drop an unwanted title for any reason as long as it meets the guidelines of the contract and therefore the predefined rules for the Publisher Rules Engine. The table in FIG. 16 assumes that the 2006 to 2007 price comparison has taken place and that this is the final price list. In the example below, per the contract, the Customer or library can drop any title that is equal to or less than 7% of the Target Spend for that year. In the example below, the Target Spend is $12,722.77 and the allowed Drop Title Amount (7% of Target Spend per contract) is $890.59. FIG. 17 is a table illustrating the final 2007 Customer Price List after the title was dropped.

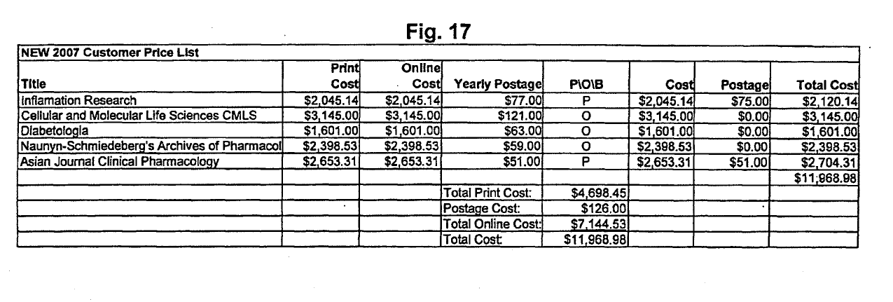

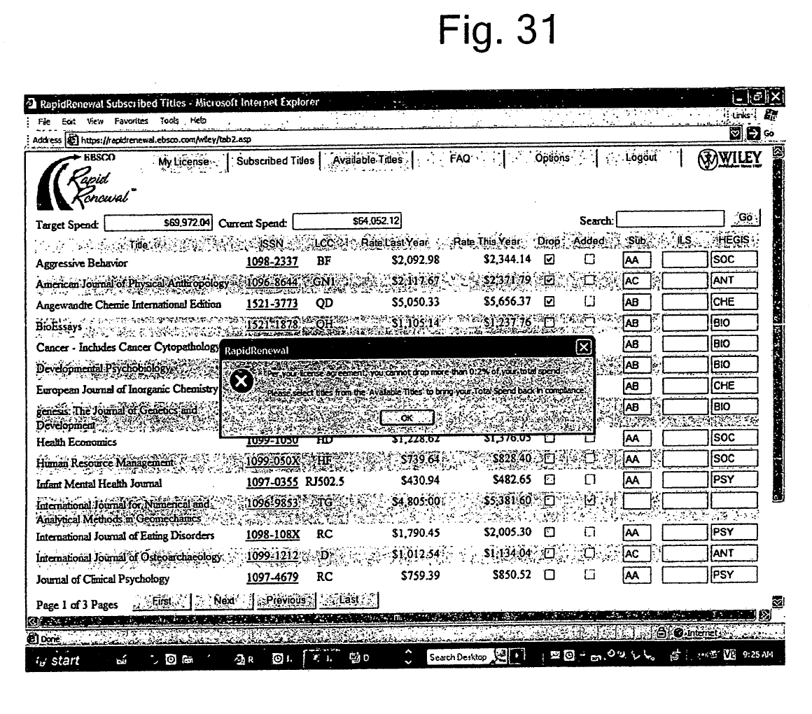

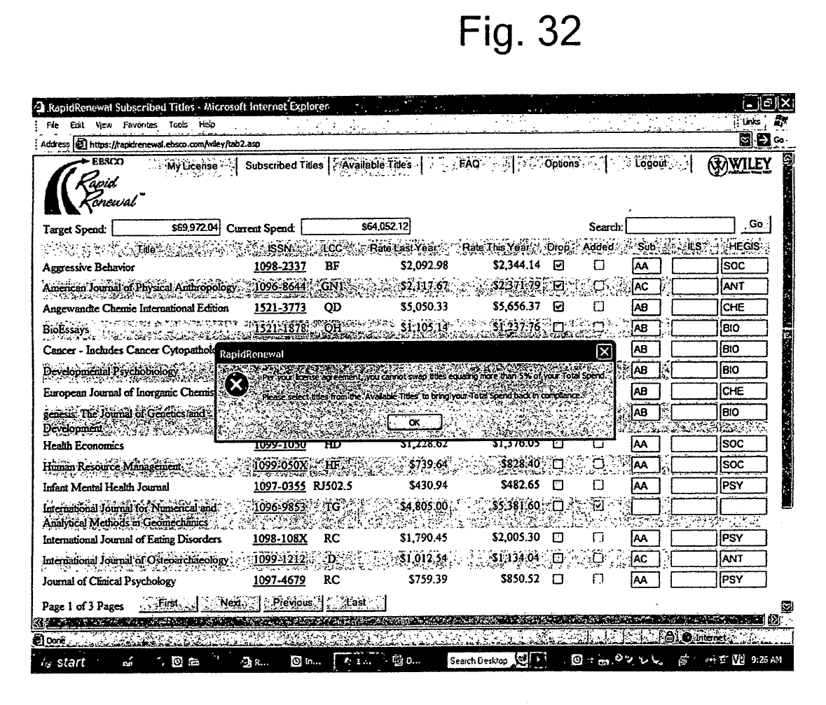

The following is an example of swapping titles, as illustrated in FIGS. 28 and 29. To calculate Swapped titles, the Actual Price Increase and the Target Spend calculations must already be completed and the dropped title would come from the new 2007 Customer Price List identified in FIG. 18. A Customer or library can swap any titles for any reason as long as it meets the guidelines of the contract and therefore the predefined rules established in the Publisher Rules Engine. In the example below, per the contract, the library can drop any title as part of a swap that is equal to or less than the percentage in the contract to the Target Spend for that year. Also, per the contract of this example, the library can add any title as part of a swap that is equal to or greater than the cost of the title that was dropped as part of the swap. Multiple titles could be added to equal the drop title as part of the swap. In the following example, the Target Spend is $12,722.77 and the Swap Title Amount (19% of Target Spend per contract) is $2,417.33. Also, in this example, the Multiplier (per contract) will apply to added titles. The Multiplier is 2 in this example and the new title that will be added as part of the swap is Cancer Research at $1,750.20 (print and online) and postage will be $43.00. If the Customer attempts to drop or swap more than allowed, then the Customer will be prompted by the screen shown in FIGS. 31 and 32 to bring their account into compliance with the License Agreement.

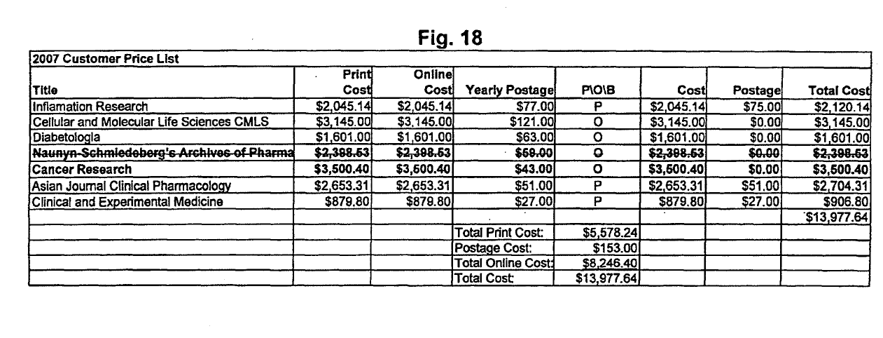

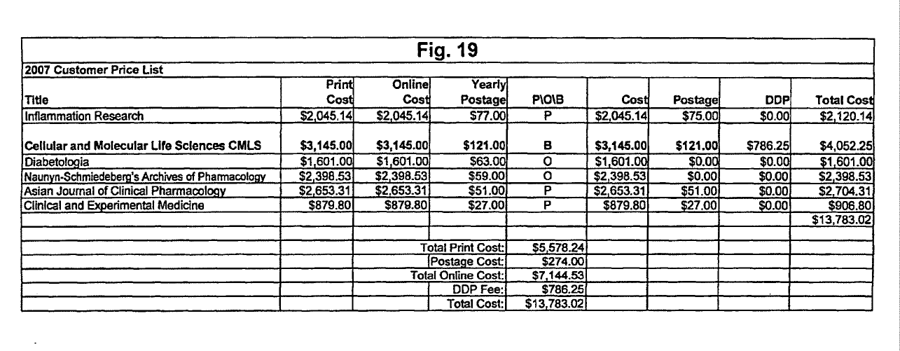

Concerning Print Plus Online, there are two basic ways that Publishers typically handle Print Plus Online access. The first method is referred to as Dual Access, in which the library pays full price for the online version and then some percentage fee (typically 5% but is stated in the contract) of the online cost for the print. Postage would be added for the print. The second method is referred to Deeply Discount Print (“DDP”). With this method, the library pays full price for the online version and then some percentage fee (typically 25% but is stated in the contract) of the print cost. Postage would be added for the print. Typically, most Publishers use only one of the two methods, but there are some Publishers that use both methods with the same Customer in the same year. Dual Access Fees and DDP are not part of the Target Spend calculation; rather, they are both considered a “fee” cost. The table of FIG. 19 is an example of a Dual Access Fee scenario with a 5% fee of the online cost, and the table of FIG. 20 is an example of a DDP scenario with a 25% print cost.

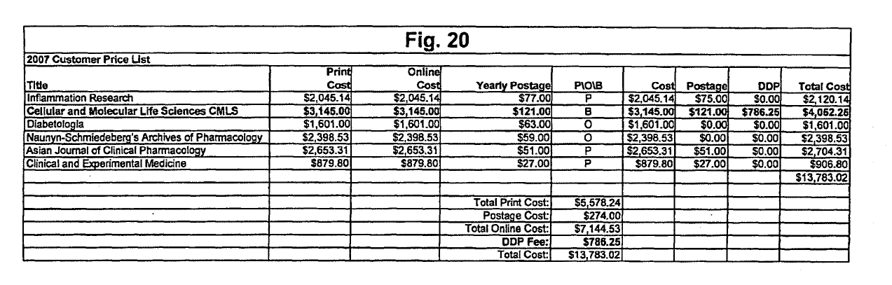

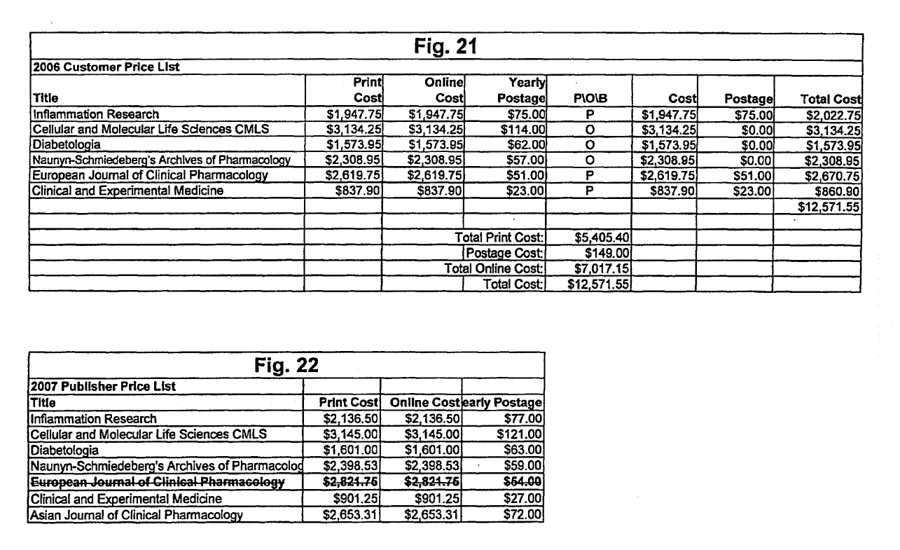

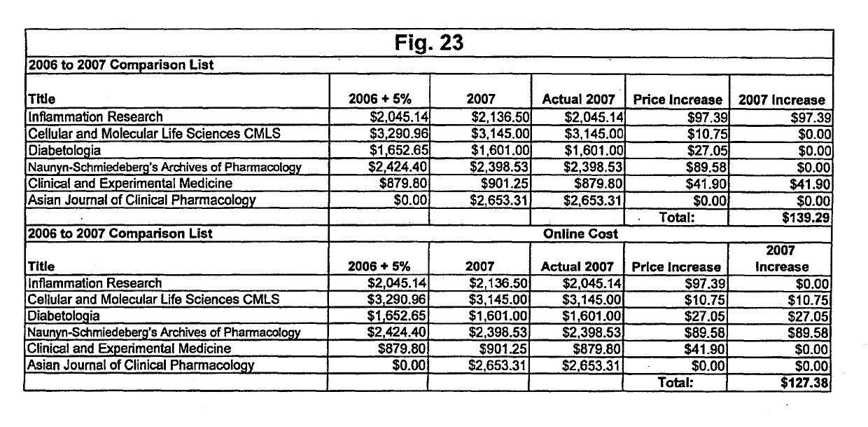

The following example illustrates all the examples listed above for a single year for a single library Price Increase, Postage, Unavailable Title, Mandatory Title, Target Spend, Dropped Title, Swapped Title, Dual Access Fee and DDP Fee. FIG. 21 provides a chart that is the original 2006 Customer price list. FIG. 22 is the Publisher's 2007 price list. On the 2007 price list, the “European Journal of Clinical Pharmacology” has been sold and therefore is an Unavailable Title and the “Asian Journal of Clinical Pharmacology,” which was a previous title for the library, has been purchased by this Publisher and therefore is a Mandatory Title. FIG. 23 is the comparison chart showing the 2006 to 2007 price comparison with increases and the Mandatory Titles. Unavailable Titles were dropped from the list. Based on this data, the Target Spend for 2007 is $12,722.77, which is calculated as follows: the amount spent in 2006 ($12,422.55) minus Unavailable Title (European Journal of Clinical Pharmacology−$2,619.75) plus 2007 Price Increase ($139.28+$127.38=$266.67) plus Mandatory Titles (Asian Journal of Clinical Pharmacology−$2,653.31) for a Target Spend for 2007 of $12,722.77.

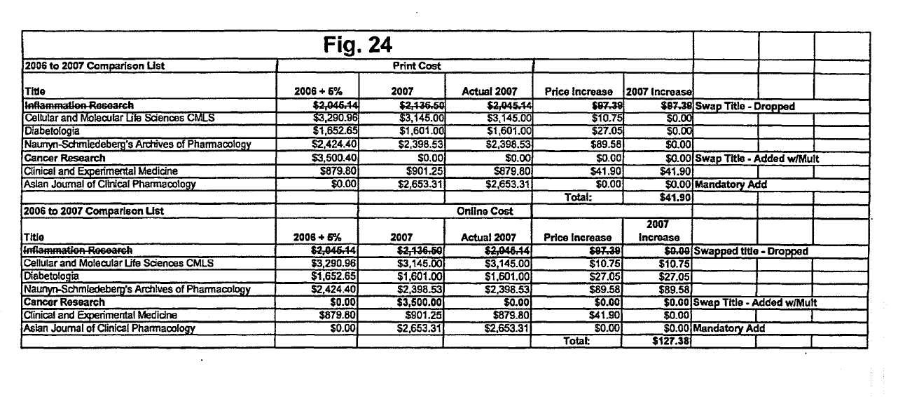

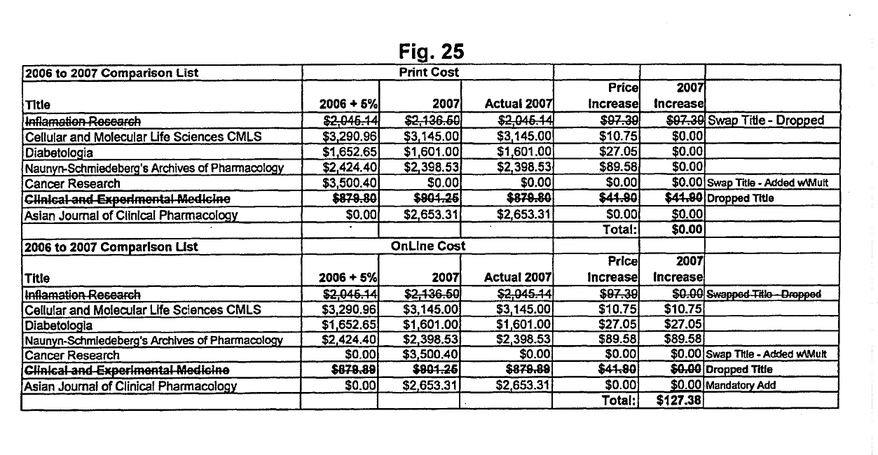

For 2007, the Customer is allowed to Swap 19% of the Target Spend for a total of $2,417.33. Based on this, the Customer is going to drop Inflammation Research and add Cancer Research at $1,750.20 for both print and online. Per the contract, a Multiplier of 2 is applied to the added titles of a Swap so the new cost to add Cancer Research will be $3,500.40. The new comparison chart is listed in the chart illustrated in FIG. 24. For 2007, the Customer is allowed to Drop 7% of the Target Spend for a total of $890.59. Consequently, the Customer is going to drop Clinical and Experiential Medicine, as shown in the updated comparison chart for 2007 illustrated in FIG. 25.

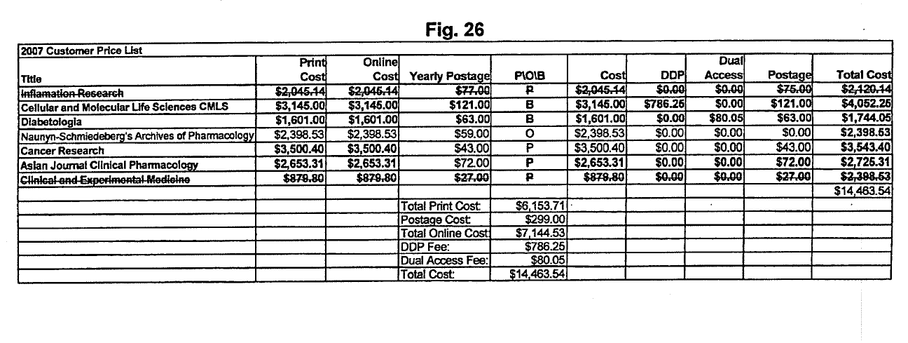

Looking to FIG. 26, the chart is the new 2007 Customer Price List with the Mandatory Titles, Swaps, and Drops. In addition, the Customer added Cellular and Molecular Life Sciences (“CMLS”) as a DDP and Diabetologia as a Dual Access Fee. Again, these fees will not be calculated in the next Target Spend figure for the following year.

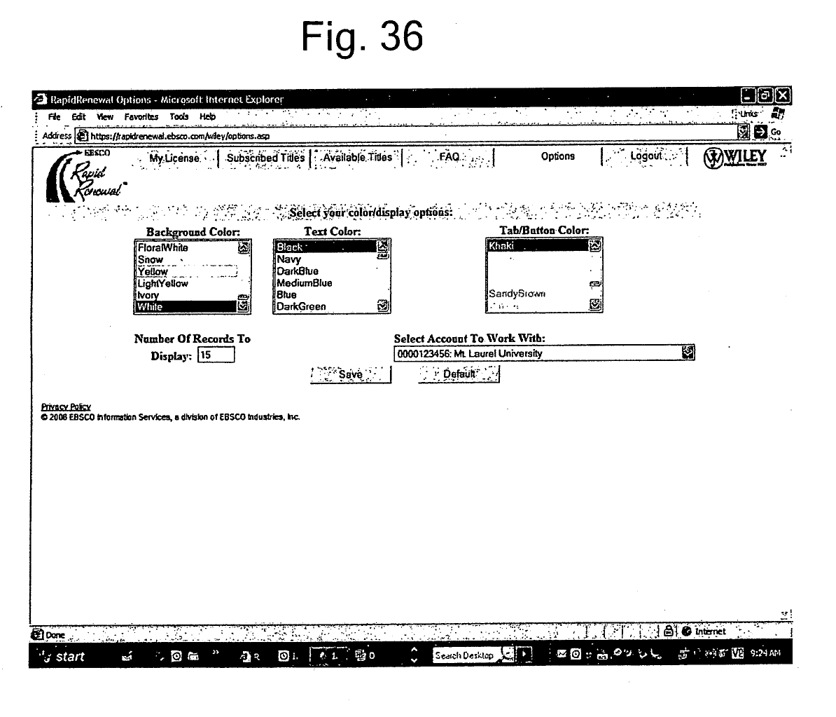

Finally, as a web based application generated by the Agent computer 12 and viewed via the Customer computer 16, the Customer will be able to adjust personal viewing preferences for the web page as desired using the interface shown in FIG. 36. That is, the Customer will be able to adjust the color of the background, text, and tabs, as well as determine the number of records displayed on a particular page with respect to a particular account, and these settings will be saved and maintained for the Customer on the Agent computer 12.

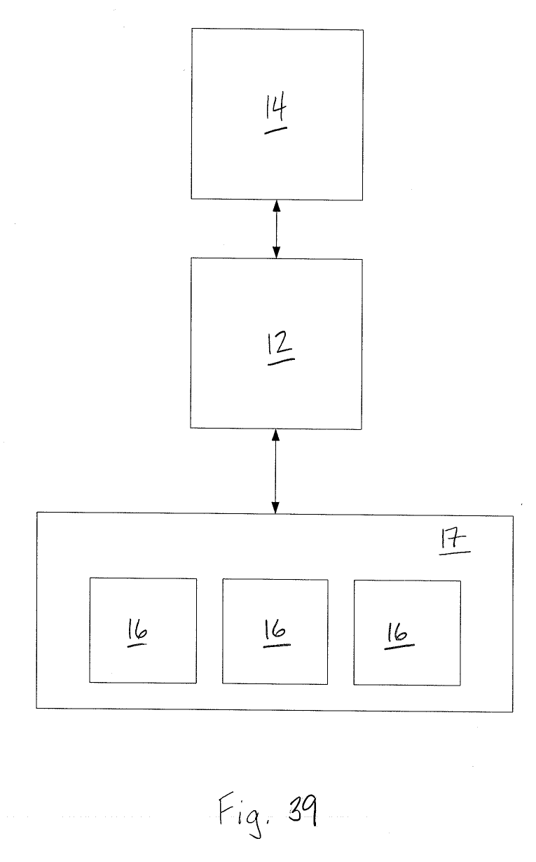

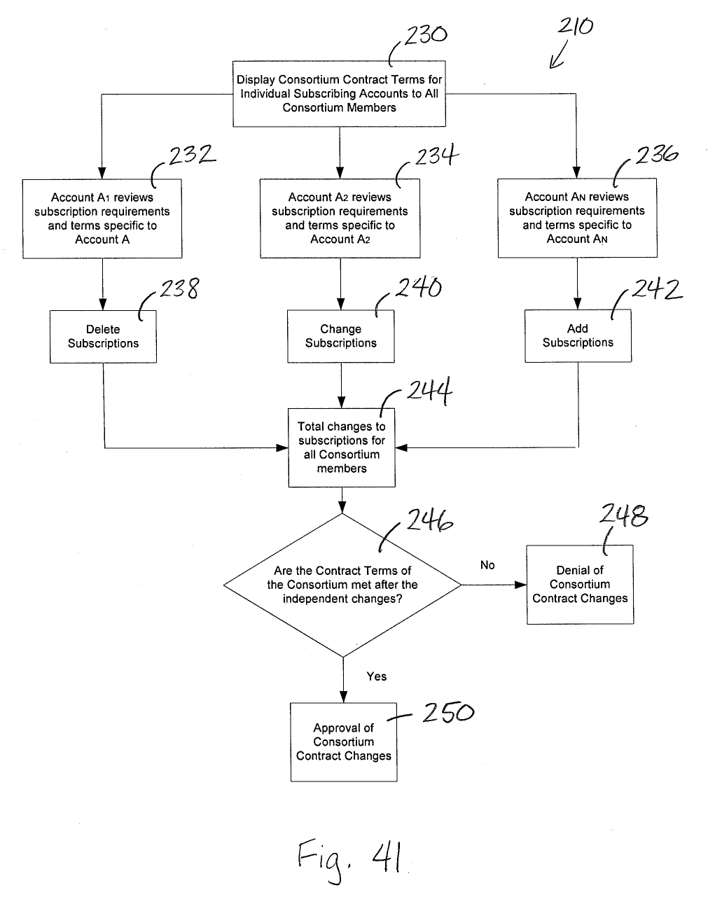

Referring to FIGS. 39-42, a process for controlling the renewals of a consortium of customers is illustrated that is similar to the steps described above includes a Consortium. In this embodiment, there are four parties: the Publisher operating the Publisher Computer 14, the Agent operating the Agent Computer 12, the Consortium having a Consortium Leader operating a Consortium computer 17, and any number of Customers operating Customer Computer(s) 16 having Individual Accounts A₁-A_{N} that are parties to the Consortium Account (see FIG. 39). The Consortium Leader is able to monitor and/or control the renewal of a package ordered by multiple group members or customers.

A Consortium Account is created with the Publisher computer 14 and the Agent computer 12, and the Contract Terms of the Consortium Account are provided to the Agent computer 12, Publisher computer 14, Consortium computer 17, and Customer Computers 16 with the Individual Accounts A₁-A_{N} that make up the Consortium (step 200). Once the Consortium Account is defined, the person or persons with access to the authorizing account can log in and view the status of the renewal for each Customer for each purchased collection of journals. The Individual Accounts A₁-A_{N} that form the Consortium Account and the associated terms are referenced, but each Individual Account A₁-A_{N} does not have to maintain the same subscription listing as provided in the previous agreement (step 202). In particular, Individual Members Accounts A₁-A_{N} of the Consortium determine the publications that they wish to maintain, subtract or add to their individual subscription list (step 204). This information is transmitted to the Agent computer 12, which will display the impact of changes by each member at the Individual Account level on the Customer computer 16 and at the Consortium level on the Consortium computer 17 (step 206), although the Consortium computer 17 will have a different landing website page than the website page for the Individual Customer computers 16. This information is monitored by the Consortium Leader (step 208). Once Individual Accounts A₁-A_{N} are satisfied with the modifications to their subscriptions, they authorize their subscription lists (step 209) and transmit the information to the Agent computer 12.

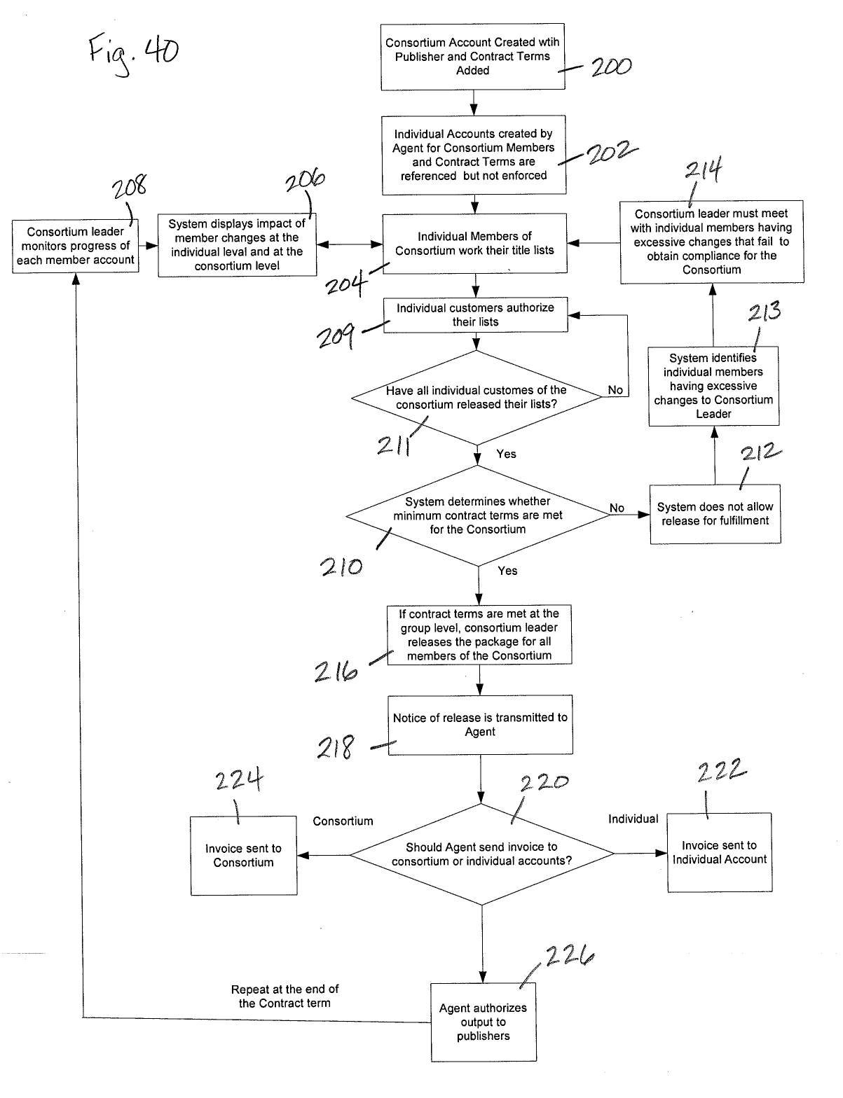

When all of the individual member computers 16 have released their lists (step 211), the Agent computer 12 will compare the combined individual subscriptions with the contractual terms of the Consortium Account to determine whether minimum contract terms for the Consortium Account have been met collectively by the consortium members A₁-A_{N} (step 210). Looking to FIG. 40, step 210 is illustrated in more detail. In particular, the Agent computer 12 will transmit and display the consortium contract terms for all individual subscribing accounts A₁-A_{N} to the Consortium computer 17 and all consortium member computers 16 (step 230). Each Individual Customer Account A₁-A_{N} will review the subscription requirements and terms specific to their specific Account A₁-A_{N} (steps 232, 234, 236). The Individual Accounts A₁-A_{N} will then determine how they wish to handle their subscriptions, such as deleting subscriptions (step 238), changing subscriptions (step 240), or adding subscriptions (step 242). The total changes to subscriptions for the Accounts A₁-A_{N} of all Consortium members is summarized, and the Agent computer 12 determines if the contract terms of the consortium are met after the changes to the Individual Accounts A₁-A_{N} (step 246). If not, then there is a denial of the proposed changes to the consortium contract terms (step 248), and the process is repeated.

Looking to FIG. 39, if the terms for the Consortium Account have not been met, then the system on the Agent computer 12 will not allow release of the package for fulfillment by the Publishers (step 212). At this point, the Agent computer 12 will identify the Individual Accounts A₁-A_{N} that have excessive changes from the previous term and provide that information to the Consortium Leader (step 213). In particular, the Agent computer 12 will identify the Accounts A₁-A_{N} that have a net reduction in the subscriptions from the previous year. Consortium Leader will then meet with at least a portion of the Individual Accounts A₁-A_{N} having excessive changes that fail to obtain compliance for the consortium (step 214), and those members will be required to edit their work title lists (step 209) until contract terms are fulfilled. If the minimum contract terms for the Consortium Account have been met at the group level, then the Consortium Leader releases the allowed package for all members of the Consortium (step 216) to the Agent computer 12. This allows the Agent to enforce contractual terms across the Consortium rather than at the individual customer level.

The notice of release is transmitted to the Agent computer 12 (step 218), and the Agent computer 12 then determines where the invoice for the Publishing Agreement from the Publisher computer 14 should be sent (step 220): either to the individual account (and potentially the Account computer 16) (step 222) or to the consortium leader (and the Consortium computer 17) (step 224). The Agent further authorizes output to the Publisher computer 14 (step 226) for the Publisher to fulfill the Consortium Contract Terms. At the end of the duration of the Contract, the Consortium Leader will again monitor the progress of each Individual Account A₁ A_{N} (step 208), and repeat the steps for individual members of the consortium to determine their work title lists (step 204).

In addition to the visual overview of the Consortium Account by the Consortium 17 and individual members 16, this functionality allows for contract terms to be enforced at a Consortium (or group) level. For example, if the contract for the Consortium states that the members are allowed to cancel up to 2% of their current spend, the Agent computer 12 will allow that cancellation to be distributed across the participants, rather than applied at the individual account level. Thus, if one customer account A₁-A_{N} wants to cancel 5% of their total 0spend, while another customer account A₁-A_{N} adds 3% of their total spend, then these cancellations are allowed under the “consortial functionality” as long as the cancellations for the Consortium group do not exceed 2% of the combined value. Thus, each customer account A₁-A_{N} may increase, drop or swap portions of the target spend as long as they fall within the allowed parameters defined for the account for the consortium.

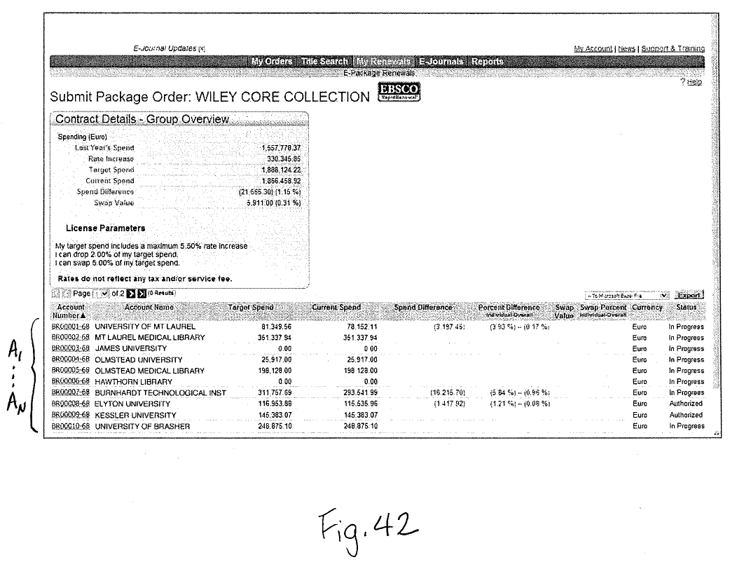

The “group overview” interface, as shown in FIG. 42, displays the spend of each individual account A₁-A_{N} as well as the required spend and the impact of any cancellations on both the spend for the individual member and the overall spend of the consortium on the member computer 16. This facilitates changes by the individual members for the consortium to meet the terms of the Consortium Contract. The consortium/group members have access to all features as described above with the exception of the final release of the purchase, and the consortium/group leader uses the group overview to monitor the renewal process and submit the renewal to the Agent computer 12 once all members have completed the individual process.

Having thus described exemplary embodiments of a METHOD FOR AUTOMATING JOURNALS AND PUBLICATIONS ORDERING AMONG A CONSORTIUM, it should be noted by those skilled in the art that the within disclosures are exemplary only and that various other alternatives, adaptations, and modifications may be made within the scope of the present invention. Accordingly, the invention is not limited to the specific embodiments as illustrated herein, but is only limited by the following claims

What is claimed is:

1. A method for ordering journals and publications comprising the steps of:
a) providing an agent computer operated by an agent in electrical communication with a publisher computer operated by a publisher and a consortium computer operated by a consortium comprising a plurality of customers, each customer having an independent customer computer;
b) providing the terms of a license agreement between the consortium and the publisher from the publisher to the agent computer;
c) generating a purchase list and holdings list of journals and publications for the consortium by the agent computer using the terms of the license agreement;
d) transmitting the purchase list and holdings list from the agent computer to the consortium computer and the customer computer;
f) adjusting the holdings list by the customer using the customer computer to add and remove journals and publications from the holdings list;
g) transmitting a finalized order from the customer computer to the consortium computer;
h) comparing the updates in the purchase list from each customer by the agent computer to confirm that minimum contract terms are met;
i) transmitting a finalized order from the consortium computer to the agent computer;
j) verifying the order by the agent computer;
k) transmitting the order from the agent computer to the publisher computer; and
l) fulfilling the order to the customers by the publisher.

2. The method as described in claim 1, wherein after step g) including the steps of:
determining the customers have a number of changes over a predetermined value;
contacting the customers having a number of changes over a predetermined value to request modification of the customer's order;
transmitting changes to the order from the customer computer to the consortium computer; and
approving the changes to the order by the consortium computer leader.

3. The method as described in claim 1, wherein prior to step c), including the steps of:
maintaining an order history database of prior year holdings by the agent computer; and
applying the prior year holdings from the order history database to generate a purchase list and holdings list of journals and publications for the consortium by the agent computer.

4. The method as described in claim 1, wherein step c) further comprises the steps of:
transmitting pricing values, added titles, and dropped titles from the publisher computer to the agent computer; and
applying pricing values, added titles, and dropped titles to generate a purchase list and holdings list of journals and publications for the consortium by the agent computer.

5. The method as described in claim 1 wherein step e) further comprises:
monitoring the list adjustments by the agent computer to for license term violations.

6. The method as described in claim 1 wherein step g) further comprises the step of:
comparing the order with the terms of the license agreement by the agent computer to confirm compliance.

7. The method as described in claim 1, wherein after step g), comprising the steps of:
sending a request from the agent computer to the customer computer for an electronic signature; and
providing the electronic signature by the customer computer to the agent computer.

8. The method as described in claim 1, further comprising the steps of:
generating an invoice by the publisher computer;
transmitting the invoice from the publisher computer to the customer computer via the agent computer; and
transmitting payment from the customer computer to the agent computer.

9. The method as described in claim 1, wherein step b) further comprises:
running a publisher data import engine by the agent computer to obtain a data file from the publisher.

10. The method as described in claim 8 further comprising the step of obtaining a data file from the publisher computer in the form of a spreadsheet.

11. The method as described in claim 8 further comprising the step of
maintaining an order history database of prior year holdings by the agent computer; and
comparing the data file from the publisher computer with the order history to remove and add files corresponding to the customer from the agent computer.

12. The method as described in claim 1, wherein step b) further comprises:
running a publisher data import engine by the agent computer to obtain a publisher data file from the publisher computer for the price list of publications and journals.

13. The method as described in claim 11 further comprising the steps of:
running a publisher data rules engine by the agent computer to compare the publisher data with a customer holding table for the previous year maintained by the Agent computer; and
transmitting all data matched from the publisher data file and the customer holding table to a temporary present year customer holding table.
